(19) United States
(12) Patent Application Publication
(10) Pub. No.: US 2005/0086696 A1
(43) Pub. Date: Apr. 21, 2005

(54) Methods for enabling near video-on-demand and video-on-request services using digital video recorders

(75) Inventor: John J. Daniels, Higganum, CT (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/970,294

(22) Filed: Oct. 21, 2004

Related U.S. Application Data
(62) Division of application No. 10/094,167, filed on Mar. 8, 2002.
Application No. 10/094,167 is a continuation-in-part of application No. 09/214,376, filed on Jan. 6, 1999, now abandoned.
Application No. 09/214,376 is a continuation-in-part of application No. 08/641,517, filed on May 1, 1996, now abandoned.
Application No. 08/641,517 is a continuation-in-part of application No. 08/306,642, filed on Sep. 15, 1994, now abandoned.
Application No. 08/306,642 is a continuation-in-part of application No. 08/038,240, filed on Mar. 29, 1993, now abandoned.

(30) Foreign Application Priority Data
Oct. 1, 1997 (WO) PCT/US97/18372

(51) Int. Cl. H04N 7/173; H04N 7/167

(52) U.S. Cl. 725/88; 725/86; 725/31; 725/105; 725/94; 725/109; 725/110; 725/112

(57) ABSTRACT

A near video-on-demand (VOD) service enabled using a digital video recorder (DVR) for the simultaneous storage and playback of multimedia data. A DVR is connected over a network to a multimedia network source. A VOD selection is requested by the DVR from the network source. A multimedia data signal is received by the DVR from the network source. The data signal contains the requested VOD selection. A first received portion of the received data signal is stored on the DVR. The first received segment is played by the DVR for display on a display device. Simultaneously during the playing of the first received segment, a second received segment of the received data signal is received from the network source and stored on the DVR while the first received segment is played the display device. Thus, the requested VOD selection begins playing on the display device prior to the reception of the entire compressed multimedia data signal so that a requested VOD selection can begin being displayed nearly instantaneously after the request for it is made. A video-on-request (VOR) service is also enabled using a DVR. VOR selection data is received by a centralized database device, such as a network server, from a plurality of users. Each VOR selection data includes at least one requested video selection and video recorder identifying information for identifying each particular video recorder. A transmission priority of requested video selections is determined dependent on the frequency of requests ¹received from the plurality of users. A transmission channel and time is determined based on the transmission priority. DVR control signals are transmitted to automatically tune in the determined transmission channel at the determined transmission time and record the particular video selection.

### CROSS REFERENCE TO RELATED APPLICATIONS

This application is a divisional of, and claims priority to, U.S. patent application Ser. No. 10/094,167, filed Mar. 8, 2002; which is a continuation-in-part of U.S. patent application Ser. No. 09/214,376, filed Jan. 6, 1999; which is a U.S. national stage application of PCT application having International Application Number PCT/US97/18372, which has a priority based on U.S. patent application Ser. No. 08/848,895, filed May 1, 1997; which is a continuation-in-part of U.S. patent application Ser. No. 08/641,517, filed May 1, 1996; which is a continuation-in-part of U.S. patent application Ser. No. 08/306,642, filed Sep. 15, 1994, which is a continuation-in-part of U.S. patent application Ser. No. 08/038,240, filed Mar. 23, 1993.

### BACKGROUND OF THE INVENTION

The present invention pertains to a method for enabling near video-on-demand (VOD) and video-on-request (VOR) services using a digital video recorder (DVR). More particularly, the present invention pertains to a method for enabling near VOD and VOR services using a DVR for the simultaneous storage and playback of multimedia data, whereby a VOD selection can begin playing on a display device shortly after being requested from a multimedia network source. Additionally, the present invention pertains to a method for enabling VOR services using a DVR, wherein the transmission priority of a particular video selection depends on the frequency of requests received for the particular video selection.

The present invention(s) described herein also pertain to a method and time shifting event recorder apparatus for pausing the display of a received time sequential signal. More particularly, the present invention(s) pertains to a time shifting event recorder capable of arbitrarily pausing the display of, for example, a television program so as to be effective in time shifting the viewing of the program.

The present invention(s) described herein also pertains to an auto-editing device, and more particularly, to an auto-editing device for use with a video recording camera and a video recorder.

Ever since events have been transmitted to and received by devices, such as radios and televisions, people have desired to be able to pause the display of the continuous event at selectable periods. Consider the example of a program being watched on a television and a viewer leaves the room to attend to a phone call. In this case, the display of the program would preferably be interrupted so that the viewer does not miss any of it. Upon returning, it is desirable to be able to resume viewing or listening to the transmitted event from the point at which the viewer left the room.

Also, when watching television, very often the viewer would like to return to a previous period in the continuously transmitted event to review that interval again. This is conventionally possible using a recording, such as a video tape of the event. In this case, the user is able to pause the video tape at any desired time. Then, at any future time the viewer can begin playing the tape again and watch the recorded event starting from the point of time on the tape at which its play back was stopped. Or, if something of interest occurs during the viewing of the recorded event, the viewer can rewind the video tape and watch that interval over and over again. After watching this interesting interval, the viewer can allow the tape to continually play to watch the rest of the event.

Currently, there are a number of transmission pathways for receiving television programming, for example, broadcast, cable and satellite television offers a viewers a variety of television channels. However, in any case the programming selection is predetermined and not under the control of the viewer. The viewer can choose which channel to tune in, but still the viewing choice is limited to the predetermined programming content.

Video-on-demand services have been attempted in the past. For example, a video-on-demand service may be configured using centralized head-end equipment on, for example, a cable television system. This centralized head-end equipment includes a bank of video players. When a subscriber requests a particular video, a request is transmitted via a phone line connection, for example, to the centralized location. The particular video is then played using the head-end equipment and the generated video signal is scrambled and transmitted over the cable television system to all of the set top boxes on the system. The scrambled signal is only de-scrambled by the requesting subscriber's set top box.

The Internet has recently exploded in popularity. Computer users are getting on-line to search for and download their choice of information from the large amount of information content already available. Business have realized the commercial prospects of having an on-line presence, and often provide their world wide web site address in print, radio and television advertisements. A computer user with a modem can get on-line and access the business' web site to obtain more information about a particular product that the user is interested in. This form of advertisement will most likely become more and more common as Internet use increases. However, the user must memorize or write down the advertiser's web site address, or perform a sometimes labor and time intensive on-line search to find the web site. If a television viewer wishes to access the advertiser's web site for more information, then he or she must wait until after the program has aired if it is desired to watch the whole program. Therefore, there is a need for a time shifting event recorder that allows a viewer to temporarily pause a program, access a computer network such as the Internet, and then resume viewing the program without missing any of it.

The accepted wisdom in the art is that a video cassette recorder can be used to make a recording of a television show so that the show can be later watched by a viewer in an asynchronous manner, that is, with pauses and replays determined according to the desires of the viewer.

In accordance with the teachings of the prior art, a dual deck recorder can be used to make copies of prerecorded tapes, or possibly record two different shows at once (if two channels can be tuned in), or possibly watch one prerecorded show while taping another.

There is no prior reference that enables a television program to be viewed at a pace dictated by the viewer, even though the television program continues to be aired. No prior device allows a viewer to watch a broadcast television program during the broadcast as if it were a prerecorded tape.

On another front, the use of a video camera for recording events has become widespread. Particularly, a video camera is pervasively used in the news-gathering field to capture images of real time events for later display and broadcast. Also, due to the advent of the home video player and video camcorder, the general public now records personal events using hand-held video cameras. A video camera uses a magnetic tape to store the images of an event for later display. New video cameras are being developed that store the recorded video image as digital information.

Typically, when filming an event a conventional video camera is set to record during durations of time that not only capture a desired portion of an event, or interesting occurrence, but which also record periods of superfluous and uninteresting footage. Since an event or interesting occurrence will often happen at times which are entirely unpredictable, to capture the desired unpredictable event the video camera must continuously record the superfluous footage, or risk the chance of not capturing the desired event.

In order to concentrate and make an interesting final product, extensive editing is usually required. Typically, this editing requires post-recording viewing of the entire videotape during which time interesting moments captured on the tape are transferred to another video tape, while leaving out the uninteresting or undesired recorded portions.

### SUMMARY OF THE INVENTION

The inventions described herein are intended to overcome the drawbacks of the conventional art. It is an object of the present invention to provide methods for enabling near VOD and VOR service using a DVR for the simultaneous storage and playback of multimedia data, whereby a video selection can begin playing on a display device shortly after being requested from a multimedia network source.

In accordance with an embodiment of the inventive method, near video-on-demand (VOD) service is enabled using a digital video recorder (DVR) for the simultaneous storage and playback of multimedia data. The inventive method includes the steps of connecting a DVR to a multimedia network source. A VOD selection is requested by the DVR from the multimedia network source. A multimedia data signal is received by the DVR from the multimedia network source. The multimedia data signal contains the requested VOD selection. A first received segment of the received multimedia data signal is stored on the DVR. The first received segment is played by the DVR for display on a display device. Simultaneously during the playing of the first received segment, a second received segment of the received multimedia data signal is received from the multimedia network source and stored on the DVR while the first received segment is played on the display device. Thus, in accordance with the present invention, the requested VOD selection begins playing on the display device prior to the reception of the entire compressed multimedia data signal. By this inventive method a requested VOD selection can begin being displayed nearly instantaneously after the request for it is made.

In accordance with the inventive method for enabling near VOD service, the DVR may be connected to a network server over a data network. The data network may include, but is not limited to, the Internet, satellite, cable television, broadcast television, power line, phone line or wireless networks. The VOD selection is requested by the DVR from the network server. A compressed multimedia data signal may be received by the DVR from the network server. The compressed multimedia data signal contains the requested VOD selection. In this case, the first received segment of the received multimedia data signal is decompressed by the DVR before the decompressed first received segment is display on the display device, such as a television or computer monitor.

In accordance with an embodiment of the inventive method for enabling near VOD service, a request is received from a DVR for a VOD selection by a network server connected to the DVR over a data network. The requested VOD selection is retrieved from a storage device associated with the network server. The requested VOD selection is transmitted in the form of a multimedia data signal over the data network to the receiving DVR. Different segments of the multimedia data signal are simultaneously played and recorded by the DVR in the manner described herein so that the requested VOD selection can begin being displayed nearly instantaneously after the request for it is made.

Another aspect of the present invention is directed to a method for providing a Video-On-Request (VOR) system. VOR selection data is received by a centralized database device, such as a network server, from a plurality of users. Each VOR selection data includes at least one requested video selection and video recorder identifying information for identifying each particular video recorder. A transmission priority of requested video selections is determined dependent on a number of requested video selections received from the plurality of users. The transmission priority of a particular video selection depends on the frequency of requests received for the particular video selection. A transmission time for the particular video selection is determined dependent on the transmission priority. A transmission channel is determined for the particular video selection. The transmission channel includes at least one of satellite, broadcast, cable, broadband and dialup Internet service and the like. DVR control signals are transmitted to the DVRs depending on the received VOR selection data and the transmission time and transmission channel of the particular video selection. If the received VOR selection data from a user includes a request for the particular video selection, the user's particular video recorder is automatically controlled to tune in the determined transmission channel at the determined transmission time and record the particular video selection. The particular video selection is transmitted at the determined transmission time and transmission channel. Thus, in accordance with the present invention, the video recorder of each user requesting the particular video selection can be controlled to automatically tune in and record the particular video selection.

The particular video selection can be transmitted as an encrypted video data file. An encryption key request may be received by the network server from a user. The encryption key is transmitted from the network server to the DVR to enable playing of the encrypted video data file so that the particular video selection may be displayed at the request of the user. The particular video selection can be transmitted as a copy-protected video data file. The VOR selection data can be transmitted via the Internet, including a web page listing available video on request titles.

### BRIEF DESCRIPTION OF THE DRAWINGS

FIG. 1(a) is a block diagram showing an embodiment of the time shifting event recorder in accordance with the present invention(s);

FIG. 1(b) is a block diagram showing in more detail an embodiment of the time shifting event recorder in accordance with the present invention(s);

FIG. 2 is a block diagram of another embodiment of the inventive time shifting event recorder;

FIG. 3(a) is a perspective view of an embodiment in accordance with another aspect of the present invention(s) for playing synchronized recordings and for producing an automatically edited version of a recorded event;

FIG. 3(b) is a perspective view of the embodiment of the present invention(s) shown in FIG. 3(a), showing user definable perspectives of the synchronized recordings played simultaneously on a monitor;

FIG. 3(c) is a block diagram of components of the embodiment of the invention shown in FIG. 3(a);

FIG. 4(a) is a block diagram of an inventive automatic edit event recording system;

FIG. 4(b) is a block diagram of an inventive automatic edit play back and edited-recording system;

FIG. 4(c) is a block diagram of an inventive automatic edit event recording system having a manual control button for selecting a beginning time of an edit-record interval;

FIG. 4(d) is a graphic illustration showing an example of a time relationship of an inventive automatic editing operation with manual beginning time selection;

FIG. 4(e) is a flow diagram of an automatic edit event recording operation in accordance with the time relationships shown in FIG. 4(d);

FIG. 4(f) is a flow diagram of an automatic edit play back and edited-recording operation in accordance with the time relationships shown in FIG. 4(d);

FIG. 4(g) is a graphic illustration showing an example of a time relationship of an inventive automatic editing operation with manual beginning time selection;

FIG. 4(h) is a flow diagram of an automatic edit event recording operation in accordance with the time relationships shown in FIG. 4(g);

FIG. 4(i) is a flow diagram of an automatic edit play back and edited-recording operation in accordance with the time relationships shown in FIG. 4(g);

FIG. 4(j) is a flow chart illustrating the operation of recording an edited version from an auto-edit signal encoded master tape;

FIG. 4(k) is a flow chart illustrating the operation of recording an analog edited version from an analog auto-edit signal encoded master tape wherein a digital recording medium is used to temporally store the edited version tape;

FIG. 5 is a block diagram schematically illustrating the components of a multi-featured multi-media appliance in accordance with the present invention(s);

FIG. 6(a) is a drawing showing a configuration of reading/writing heads of recording means associated with a same recordable disk recording medium;

FIG. 6(b) is another configuration of reading/writing heads of recording means associated with a same recordable disk recording medium;

FIG. 7(a) shows a block diagram of a configuration of the inventive time shifting event recorder wherein an electronic storage medium is constructed on a video card for easy assembly into media appliances and devices;

FIG. 7(b) shows a block diagram of a configuration of the inventive time shifting event recorder for arbitrarily pausing the display of a video signal, such as a television program;

FIG. 8 shows a flowchart of an algorithm showing the operational steps of the configuration of the inventive time shifting event recorder shown in FIG. 7;

FIG. 9 is a flowchart of an algorithm showing the operational steps of a time shifting event recorder in accordance with the present invention;

FIG. 10 is a flowchart of an algorithm showing the operational steps of a time shifting event recorder used to enhance the performance of a pay-per-view system;

FIG. 11(a) is a timing chart of the prior art reception and recording of a faster-than-real-time compressed file containing a pay-per-view movie, and the subsequent viewing of the movie;

FIG. 11(b) is a timing chart of the reception and recording of a faster-than-real-time compressed file containing a pay-per-view movie, and the simultaneous viewing of the movie;

FIG. 11(c) is a timing chart similar to FIG. 11(b) with a high compression rate for the compressed file;

FIG. 12(a) is a flow chart of an algorithm showing an embodiment of the inventive method for enabling near video-on-demand (VOD) service using a digital video recorder (DVR) for the simultaneous storage and playback of multimedia data;

FIG. 12(b) is a flow chart of an algorithm showing another embodiment of the inventive method for enabling near VOD service;

FIG. 12(c) is a flow chart of an algorithm showing another embodiment of the inventive method for enabling near VOD service;

FIG. 13(a) is a schematic diagram illustrating the transmission path of data between a source of VOD selections and a client machine;

FIG. 13(b) is a schematic diagram illustrating another transmission path of data between the source of VOD selections and a client machine;

FIG. 13(c) is a schematic diagram illustrating another transmission path of data between the source of VOD selections and a client machine;

FIG. 13(d) is a schematic diagram illustrating another transmission path of data between the source of VOD selections and a client machine;

FIG. 14 is a flow chart showing the basic steps of the inventive video-on-request (VOR) system;

FIG. 15 is a flow chart further describing the steps of an embodiment of the inventive VOR system; and

FIG. 16 is a flow chart also describing the steps of an embodiment of the inventive VOR system.

### DETAILED DESCRIPTION OF THE INVENTION:

A conventional television set allows a viewer to decide what to watch, but not when to watch it. Each television program is broadcasted from a television station, beamed via satellite, and/or carried over a cable, to each receiving television set in a synchronous manner. Stated otherwise, each television set that is tuned to a particular channel receives the same television program starting and ending at the same times. Those who wish to view a program must synchronize their schedules with the time of the program broadcast. Video tape recorders have become very popular devices because they let a viewer watch a program asynchronously, but only after the program has been aired. That is, a viewer can watch the recorded program at any time he or she desires. A VCR can be programmed to record a certain channel at a certain time to record a program. A viewer can then view the program at a later time by replaying the recorded VCR tape. However, a viewer still must wait until the entire program has been received and recorded before viewing the play back from the VCR tape.

A video signal contains a large amount of information, and thus requires a recording scheme with a large storage capacity to record, for example, a television program in its entirety (as can be done using a conventional VCR). Recently developed video compression technology (such as MPEG) and recording media (such as high capacity disk drives, Jazz drive from Iomega and the like) now enables a useful amount of video information to recorded in a random access manner. This recent technology includes other formats of video compression, as well as recordable compact disks, digital video disks, magneto-optical disks, phase change optical disks, and the like. Companies such as Sony, Hitachi and 3M are increasing the storage capacity of magneto-optical disks, and Matsushita is making advances in phase change storage technology. This newly developed technology enables storage of large amounts of video information, and can be used to enable the recording and playback features of the inventive device. Further advances in the speed and storage capacity of recordable media are expected, which could also be advantageously utilized by the present invention(s).

In accordance with the present invention(s), a viewer can pause the display of, for example a television program, at any time and for any length of time (limited by the recording capacity of the recording media). The pause can take place while the program is being aired, and the viewer can return to viewing the program from the point where the pause began, even while the program continues to be received. During the pause the viewer may replay a previously recorded portion of the program, fast forward through a recorded portion, simply take a break from viewing and/or switch to another channel. Also, the present invention(s) allows a viewer to pause the display of a program and switch to another media system, such as an Internet connection. The viewer can access information from the Internet computer network while pausing the display of a television program.

As an example of this application for the present invention(s), the time sequential signal that carries a television program usually includes commercial messages. The commercial message may include information regarding an advertiser's world wide web site, or other computer network address. The address may be included as information contained in the video vertical blanking interval (a portion of the video signal that is received during a time when the video display scanning returns to the top of the screen). This address information can be accessed so that a viewer can access the advertisers computer network location for more information on a particular product that is described in the commercial message. The viewing of the program can be time shifted while the viewer accesses the advertiser's computer network site. Once the viewer has reviewed the computer network site, he can return to the television program without missing any of it.

The present invention(s) described herein facilitates the convergence of a bulk information transfer medium (television) and a personalized, nearly unlimited source of substantive information (the Internet) by allowing access to on-line content during the user-determined pause. Relevant on-line content can be linked to the program via information embedded in the television signal, or, on-line content can provide a link to a related broadcast, cable or video-on-demand television program.

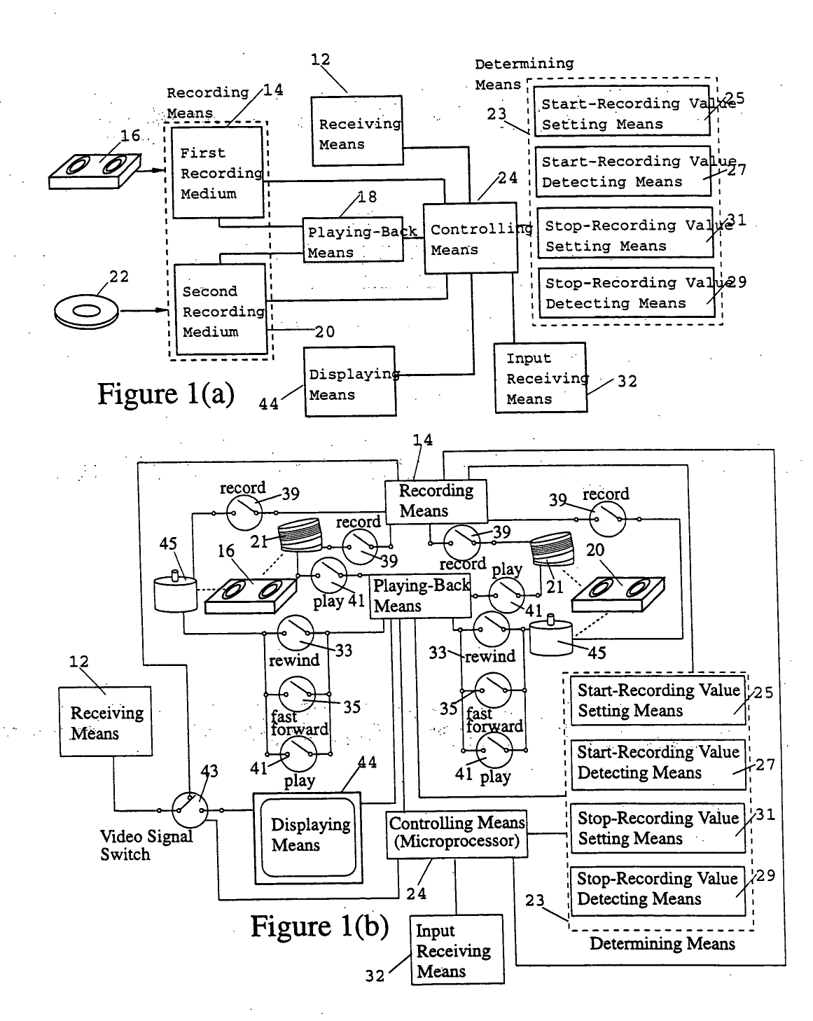

Referring to FIG. 1(a), an embodiment of the inventive time shifting event recorder will be described. Receiving means 12 receives a time sequential signal representing an event. The time sequential signal may be transmitted as packets of compressed video and audio information. Each packet may not necessarily be received in the correct chronological order. However, the received packets can be stored and then the program reconstructed by replaying the video and audio information of the stored packets in the correct chronological order.

In accordance with the present invention(s), a first recording means 14 records in a first recording medium 16 at least one selected portion of the time sequential signal. In other words, if the viewer of a television program were to leave the room, the first recording means 14 is activated to record that selected portion of the time sequential signal received during the viewer's absence. Upon returning, the viewer activates the playing-back means 18 to retrieve at the selectable interval (the viewer's return), the recorded selected portion of the time sequential signal recorded in the first recording medium 16 during the viewer's absence. The playing-back means 18 produces a play back signal from this recorded time sequential signal portion so that the viewer can view the television program where he or she left off. While the viewer is viewing the time shifted portion of the television program, a second recording means 20 records in a second recording medium 22 another selected portion of the time sequential signal. In other words since the television program continues on time sequentially, while the viewer is viewing the first recorded portion recorded in the first recording medium 16, the second recording means 20 continues recording the time sequential signal at the point at which the recording by the first recording means 14 is stopped so that the signal can be played back.

After the time sequential signal recorded by the first recording means 14 has been played back (so that the viewer is able to view that portion of the television program that was aired in his absence), the playing-back means 18 retrieves the portion of the time sequential signal recorded by the second recording means 20 so that it may be played back. Thus, the continuous time sequential signal representing the event (the television program) is time shifted and the viewer views the program continuously upon returning, starting from the point in time at which the viewer first stopped viewing the program.

Controlling means 24 controls the first and second recording means 14,20 to record the respective selected portions of the time sequential signal. The controlling means 24 also controls the playing-back means 18 to retrieve at the selectable intervals the respective selected portions of the time sequential signal, so that the play back signal can be generated and a representation of the event can be produced in a time shifted manner. The time sequential signal can be a video signal or an audio signal. The recording media can be a magnetic tape, a magnetic disk, an electronic memory circuit (such as an EPROM, or other electronic storage device) an optically recordable disk recording medium, or any recording medium now known or later developed suitable for the intended purposes described herein.

FIGS. 1(a) and 1(b) show an inventive recording device for pausing the display of a received time sequential signal (TSS) on a displaying device, such as a television, computer monitor, or radio. In accordance with the present invention(s) recording means 14 is provided for recording a first recorded portion of a received time sequential signal. The recording means 14 also records a second recorded portion of the received time sequential signal. Input receiving means 32 is provided for inputting a pause display command and a resume display command. The pause display command and the resume display command are instructions received from the viewer (via a remote control, voice activation mechanism, computer keyboard, or mouse, for example) to allow the control of the viewing of, for example, a television program depending on the viewer's preference.

Determining means 23 is provided for determining a beginning of the first recorded portion. The determining means 23 includes a start-recording value setting means 25 for setting a start-recording value. As will be described in more detail below, the start-recording value is utilized for determining where on the recording medium the beginning of a recorded portion of the time sequential signal is physically (or electronically) located. For example, the start-recording value may be a counter value that corresponds to where on a VCR tape or other magnetic recording tape the beginning of a recorded portion of the time sequential signal is located. The counter may be an electronic digital counter that provides a counter value signal which can be stored in a memory device, such as a RAM. Each counter value signal corresponds to a segment of the length of the VCR tape.

The counter of the VCR does not necessarily have to be used to provided the counter value. For example, The microprocessor clock can be used to count the time that a segment is recorded. A factor is determined that depends on the time it takes to rewind a given number of seconds of recorded tape by determining how long it takes for a given unit of VCR tape containing the given numbers of seconds to be rewound during the rewind operation. To get back to the beginning of a recorded portion, the time of the recorded segement is determined and this time is multiplied by the determined factor. The VCR is then controlled to rewind the video tape by the amount needed to return it to the start of the recorded segment.

Playing-back means 18 is provided for playing back the recorded portions of the time sequential signal (i.e., the first recorded portion and the second recorded portion). Controlling means 24 controls the determining means 23 to determine the beginning of the first recorded portion depending on the pause display command. The controlling means 24 may thus control the start-recording value setting means 25 depending on and in response to the received pause display command. When the pause display command is received, the start-recording value setting means 25 sets the start-recording value so that after the portion of the time sequential signal has been recorded its beginning can be located.

The controlling means 24 also controls the recording means 14 so that the first recorded portion is recorded depending on the pause display command. Once the first recorded portion of the time sequential signal has been recorded and the viewer wishes to begin viewing the program again, the controlling means 24 controls the playing-back means 18 so that the first recorded portion is played back depending on the start-recording value, and depending on and in response to the resume display command. The controlling means 24 also controls the recording means 14 so that the second recorded portion is recorded while the first recorded portion is being played back.

In accordance with the present invention(s), the recording means 14 comprises at least one of a magnetic recording tape, a magnetic recording disk, an optical recording disk, an electronic recording circuit, and a recording medium. The recording medium may be, for example, a magnetic recording medium, an optical recording medium, a holographic recording medium, or an electronic recording medium. In the case of an electronic recording medium, a dynamic random access memory (DRAM) may be used. An example of such a DRAM is to be produced by NEC Corporation of Japan. NEC Corp. has prototyped a DRAM chip that can store more than 4 billion bits of information, enough to hold more than half-an-hour of full-motion video. Compression techniques, such as MPEG, may be employed to store a greater amount of video on such a chip. In accordance with the present invention(s), a single DRAM may be used as both the first and the second recording mediums 16, 22 if it is capable of simultaneously recording and playing back information. Alternatively, two or more DRAMs can be utilized as the respective first, second (and if desired third, and so on) recording mediums. In any event, the operation of the recording and playing back of the received time sequential signal will be controlled as described herein to enable a viewer to arbitrarily pause the display of, for example, a received television program, and then later return to the viewing of the program without missing any of it and even while the rest of the program continues to be received. The DRAM may be used as a buffer memory to store a portion of the time sequential signal to allow a non-random access recording medium, such as a conventional VCR video tape to be employed as either or both of the first and the second recording mediums 16,22. In place of the DRAM, an other random-accessible data storage device can be used, such as a hard drive, removable cartridge drive, holographic memory, etc.

In the case of an electronic storage device, such as a DRAM configuration, the inventive time shifting event recorder can be constructed as, for example, an expansion card that can be incorporated into an existing device. For example, a DRAM configuration for the video storage mediums described herein can be incorporated on a PCI or similar card along with the necessary ancillary microprocessor(s) and other electronic components to enable the time shifted recording capabilities described herein. It is likely that up and coming multimedia devices, such as Internet appliances, set top boxes, so-called network computers, high definition televisions, computers, VCRs, DVD drives, etc. will include provisions for exapanding the devices capabilities either during the initial product configuration by the distributor or through upgrades that can be incorporated after the consumer has purchased the device. The electronic memory (i.e., DRAM and the like) provides a convenient vehicle to enable such devices to be configured or retrofitted with the many advantages of the inventive time shifting event recorder. If the historic trends continue, it is very likely that the capacity and speed of such electronic memory components will increase, while their costs decrease, making this implementation of the inventive time shifting event recorder even more compelling to the consumers of multimedia and like devices.

As will be described below, the use of other recording media, such as optical or magnetic disks, may utilize different mechanisms for determining the beginning and ending of the recorded portions of the time sequential signal. The type of start-recording value setting means 25 utilized in accordance with the present invention(s) will depend upon the type of recording means 14 utilized. However, it is important to note that in accordance with the present invention(s) the recording means 14 utilized may be comprised of two or more different types of recording media, such as a VCR tape and an optical disk. The inventive recording device can be utilize in conjunction with a VCR tape recorder so that the necessary component parts (recording/play back head, motor 45, circuitry) of the inventive recorder are reduced while still allowing the unique and useful functionality of pausing the display of a time sequential signal on a displaying device 44, such as a television, depending on the viewer's preference. The start-recording value comprises at least one of a tone signal, a counter value, file allocation table address, and a location on a recording medium.

In accordance with the present invention(s), the determining means 23 may include stop-recording value setting means 31 for setting a stop recording value. The stop-recording value indicates where the end of each recorded portion of the time sequential signal is located on the recording medium. The invention further includes stop-recording value detecting means 29 for detecting the stop-recording value. The stop-recording value setting means 31 may comprise one of a tone signal generator, a counter, a file allocation address generator, and a recording medium location address storing means. The stop-recording value may comprise at least one of a tone signal, a counter value, a file allocation table address, and a location on a recording medium.

Stated otherwise, the inventive apparatus for pausing the display of a received time sequential signal includes recording means 14 for recording a first recorded portion of a received time sequential signal and for recording a second recorded portion of the received time sequential signal. Input receiving means 32 inputs a pause display command and a resume display command. Determining means 23 determines the beginning of the recorded portion. Playing-back means plays back the first recorded portion and the second recorded portion in a time-shifted manner. In accordance with the present invention(s), controlling means 24 controls the determining means 23 to determine the beginning of each recorded portion depending on the pause display command. When the pause display command is received, the determining means 23 makes an indication of the physical or electronic location of the beginning of the recorded portion. This indication (start-recording value) is used for finding where each recorded portion begins. The physical location of the beginning of each recorded portion may be, for example, a segment of a recording tape, or a sector and/or track of a recording disk, etc. The electronic location may be an address of a memory circuit, etc. The controlling means 24 controls the recording means 14 so that the first recorded portion is recorded depending on the pause display command. When the pause display command is received, the recording means 14 begins recording a recorded portion of the time sequential signal. The controlling means 24 also controls the playing-back means so that the first recorded portion is played back depending on the beginning determined by the determining means 23 and depending on the resume display command. The controlling means 24 also controls the recording means 14 so that the second recorded portion is recorded simultaneously while the first recorded portion is being played back. The recording of the second recorded portion depends on the received resume display command, since after taking an initial break when the viewer wishes to resume viewing the program, the viewer inputs the resume display command to the controlling means 24 (via remote control, voice activation circuitry, keyboard, mouse, or other input device). The first recorded portion is then played back, while the second recorded portion of the time sequential signal is recorded.

In accordance with the present invention(s), the controlling means 24 includes determining means 23 for determining if the ending of the first recorded portion has been played back. As long as the ending of the first recorded portion has not been played back, then the controlling the playing-back means continually plays back the first recorded portion of the time sequential signal, while simultaneously recording the second recorded portion of time sequential signal. If the ending of the first recorded portion has been played back, the controlling means 24 is effective for controlling the recording means 14 for recording an ending of the second recorded portion of the time sequential signal on the first recording medium 16. Then, the controlling means 24 controls the playing-back means for playing back the second recorded portion of the time sequential signal using the second start-recording value to determine the beginning of the second recorded portion.

In accordance with the inventive apparatus, the start-recording value setting means 25 may also be effective in setting a third start-recording value, a fourth start-recording value and so on, allowing the viewer to take any number of breaks in the viewing of the continuously received time sequential signal by recording third, fourth, etc. recorded portions that are played back in a time shifted manner. In accordance with the present invention(s), time shifting is defines as allowing a viewer to view a conventionally synchronous program in an asynchronous manner.

In the case of a third recorded portion, for example, the recording means 14 records a beginning of a third recorded portion of the time sequential signal on the first recording medium 16. The third recorded portion can be recorded on a third recording means 14, or the first and the third recording means 14 can be one in the same. If the first recorded portion has already been played back, then the third recorded portion can be recorded over it, or at least a portion of the third recorded portion can be recorded on a different location of the recording medium holding the first recorded portion. The controlling means 24 controls the determining means 23 to be effective for determining if the ending of the second recording portion has been played back. If the ending of the second recorded portion has not been played back, then the controlling means 24 controls the playing-back means for continuing playing back the second recorded portion of the time sequential signal, while simultaneously recording the third recorded portion of the time sequential signal. If the ending of the second recorded portion has been played back (i.e., the second stop-recording value is detected) then the controlling means 24 controls the recording means 14 to record an ending of the third recorded portion of the time sequential signal on the first recording medium 16. Then, the controlling means 24 controls the playing-back means to play back the third recorded portion of the time sequential signal using the third start-recording value to determine the beginning of the third recorded portion, and so on, playing back the recorded portions in the order that they were recorded, while allowing the viewer to pause the display, rewind and review, fast forward, etc., making viewing of the program asynchronous and under the complete control of the viewer.

The determining means 23 further includes stop-recording value setting means 31 for setting a first stop-recording value for determining the ending of the first recorded portion. In this case, the determining means 23 includes means for determining if the ending of the first recorded portion has been played back by detecting the first stop-recording value.

In accordance with the inventive apparatus, the determining means 23 includes means for determining if the ending of the first recorded portion has been played back. If the ending of the first recorded portion has not been played back, then the controlling means 24 controls the determining means 23 to determine if a viewer selected function is received. The viewer selected function may be, for example, rewinding, fast forward, stop, etc.

If the viewer selected function is received, then the function is performed while simultaneously continuing to record the second recorded portion (or the next recorded portion from the recorded portion that is being played back) of the time sequential signal. If the viewer selected function instruction is not received, then the controlling means 24 controls the playing-back means to continue playing back the first recorded portion of the time sequential signal, while the recording means 14 simultaneously continues to record the second recorded portion of the time sequential signal. The viewer can arbitrarily choose to review a portion of the program that has already been viewed by rewinding or otherwise returning the play back from the recording medium to that portion of the program and letting it play again. While the rewinding and replaying of the recorded portion is taking place, the program (which continues to be aired) is simultaneously and continuously recorded on, for example, the second recording medium 22 so that the viewer does not miss any of the program. Further the viewer can fast forward through commercials, or the commercials may be blanked out by detecting the information of the vertical blanking interval from the video signal.

If the ending of the first recorded portion has been played-back, then the controlling means 24 controls the recording means 14 to record an ending of the second recorded portion of the time sequential signal on the second recording medium 22. Then, the controlling means 24 controls the playing-back means to play back the second recorded portion of the time sequential signal using the second start-recording signal value, in a manner similar to the playing back of the first recorded portion.

As shown in FIG. 1(b), the controlling means 24 may include a microprocessor that is preset to control the performance of the operations of the inventive method as described herein. Recording means 14 records a recorded portions (first recorded portion, second recorded portion, and so on) of a received time sequential signal. The recording means 14 includes a recording/playback head 21 to magnetically record the received portion of the time sequential signal on a recording medium, such as a VCR tape. The recording means 14 also includes a motor 45 for advancing the recording medium during the recording process. The controlling means 24 controls the recording means 14 by appropriately actuating record switches 39 that activate the recording/play back head 21 and the motor 45 to effect the recording process. In the configuration shown in FIG. 1(b), the recording means 14 is effective for recording on a first recording medium 16 and on a second recording medium 22, although, as described herein one or more recording media may be utilized, depending on the configuration of the inventive recording apparatus.

Input receiving means 32 are provided for inputting a pause display command and a resume display command. The input receiving means 32 allows the viewer to asynchronously determine the viewing of the received program, and allows the viewer to input selected functions, such as rewind, fast forward, stop, play, pause, etc. Determining means 23 determines the beginning of the each recorded portion, and playing back means 18 for plays back the recorded portions of the time sequential signal. The determining means 23 includes start-recording value setting means 25 for setting a start-recording value, and start-recording value detecting means 27 for detecting the set start-recording value. The determining means 23 may also include stop-recording value setting means 25 for setting a stop-recording value and stop-recording value detecting means 29 for detecting the stop-recording value.

The playing back means 18 includes the recording/playback head and the motor 45 for advancing the recording medium during the playing back process. The controlling means 24 controls the playing back means 18 by appropriately actuating play switches 41 that activate the recording/play back head 21 and the motor 45 to effect the playing back process. In the configuration shown in FIG. 1(b), the playing back means 18 is effective for playing back recorded portions from a first recording medium 16 and from a second recording medium 22, although, as described herein one or more recording media may be utilized, depending on the configuration of the inventive recording apparatus.

The controlling means 24 controls the determining means 23 to determine the beginning of the first recorded portion depending on the pause display command. The controlling means 24 also controls the recording means 14 so that the first recorded portion is recorded depending on the pause display command. The controlling means 24 further controls the playing back means 18 so that the first recorded portion is played back depending on the determining of the beginning portion by the determining means 23 and depending on the resume display command. In addition, the controlling means 24 controls the recording means 14 so that the second recorded portion is recorded while the first recorded portion is being played back.

The controlling means 24 controls the start-recording value setting means 25 to set the start-recording value depending on the pause display command, and the controlling means 24 controls the playing back means 18 so that the first recorded portion is played back depending the start-recording value and the resume display command.

In accordance with the present invention(s), the recording means 14 comprises at least one of a magnetic recording tape, a magnetic recording disk, an optical recording disk, an electronic recording circuit and a recording medium. The stop-recording value setting means 25 comprises at least one of an audio signal generator, a counter, a file allocation table address generator, and a recording medium location address storing means. The stop-recording value comprises at least one of an audio signal, a counter value, a file allocation table address and a location on a recording medium.

The controlling means 24 controls the playing back means 18 and the recording means 14 to appropriately control the recording/play back head 21 and the motor 45 by controlling the actuation of switches (rewind switch 33, fast forward switch 35 and play switch 41), as well as the record switch 39 and the play switch 41. The time sequential signal is received by the receiving means 12 and sent to, for example, a video signal switch 43, which is under the control of the microprocessor of the controlling means 24. When the time sequential signal is being viewed as it is received (like the conventional manner), then the video signal switch 43 is controlled to send the received time sequential signal to the displaying means 44. When viewing of the time sequential signal is being time shifted, the video signal switch 43 is controlled by the microprocessor to transfer the received time sequential signal to the recording means 14.

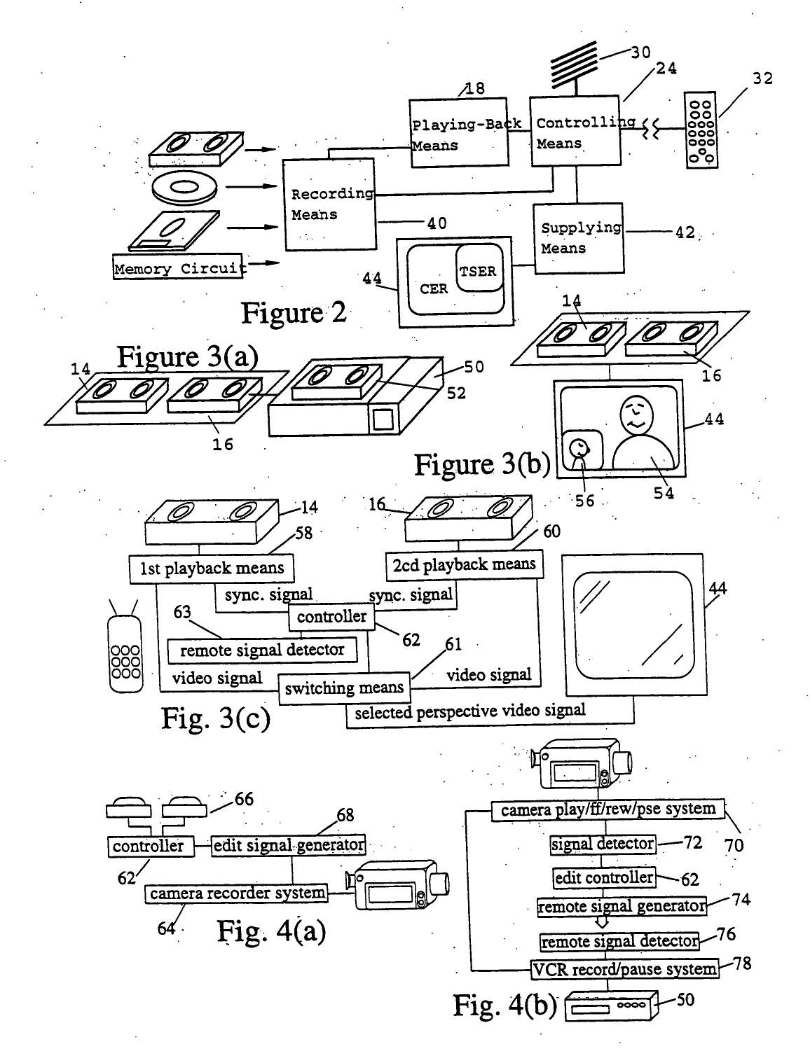

Referring now to FIG. 2, an embodiment of the inventive time shifting event recorder for displaying a time shifted representation of an event on a display device is shown. Receiving means 12, such as an aerial antenna 30 for receiving a broadcast signal or a cable coaxial receiver, receives a time sequential signal representing an event (such as a television program). At least one recording means 40 records in a respective recording medium at least one respective selected portion of the time sequential signal. Playing-back means 18 retrieves at respective selectable intervals each respective selected portion of the time sequential signal recorded in each recording medium, and generates a respective play back signal dependent thereon. Controlling means 24 controls each recording means to record each respective selected portion of the time sequential signal. The controlling means 24 also controls the playing-back means 18 to retrieve at each respective selectable interval each respective selected portion of the time sequential signal, so that the playing-back means 18 generates each respective play back signal. Thus, a representation of an event can be produced in a time shifted manner (as described above with reference to FIG. 2(a) and 2(b)).

In this embodiment of the present invention(s), as shown in FIG. 2, supplying means 42, controlled by the controlling means 24, supplies at least one of the respective play back signals and a current portion of the time sequential signal to a display device 44 simultaneously so that at least one time shifted representation of the event can be displayed simultaneously with a current representation of the event on the display device. In other words, a time shifted event representation TSER can be displayed at one portion of a television screen while a current event representation CER is displayed at another portion of the television screen. In this way, the viewer can choose to recall and review again a selected portion of the television program while continuing to view the current event representation in real time.

In accordance with the present invention(s), supplying means 42 controlled by the controlling means 24 supplies at least two of the respective play back signals to a display device simultaneously so that at least two time shifted representations of the event can be displayed simultaneously on the display device. In other words, in accordance with one embodiment of the present invention(s) the time sequential signal of an event, such as a television program, is recorded as shown by way of example in FIGS. 2(a) and 2(b). At the user's option, two or more portions of the event can be replayed simultaneously and viewed by the viewer on a display device 44, such as a television set. As with the other embodiments, each recording medium may be a magnetic tape, magnetic disk, electronic memory circuit (such as an integrated circuit device disposed on a silicon chip), an optically recordable disk or other suitable recording medium. It is particularly noted that various means for recording information are being constantly developed. Therefore, the present invention(s) is intended to include the use of such information storage devices whether currently known or developed at such future time. As with a previously described embodiment, in accordance with the embodiment shown in FIG. 2, each recording medium can be a portion of a recordable disk so that each recording means writes to and reads from the same recordable disk. Alternatively, each recording medium can comprise a portion of memory of a same electronic memory circuit. In this case, each recording means stores information on a same electronic memory circuit. Furthermore, as with the other embodiments, each recording means may record the time sequential signal as digital data, analog data or the like.

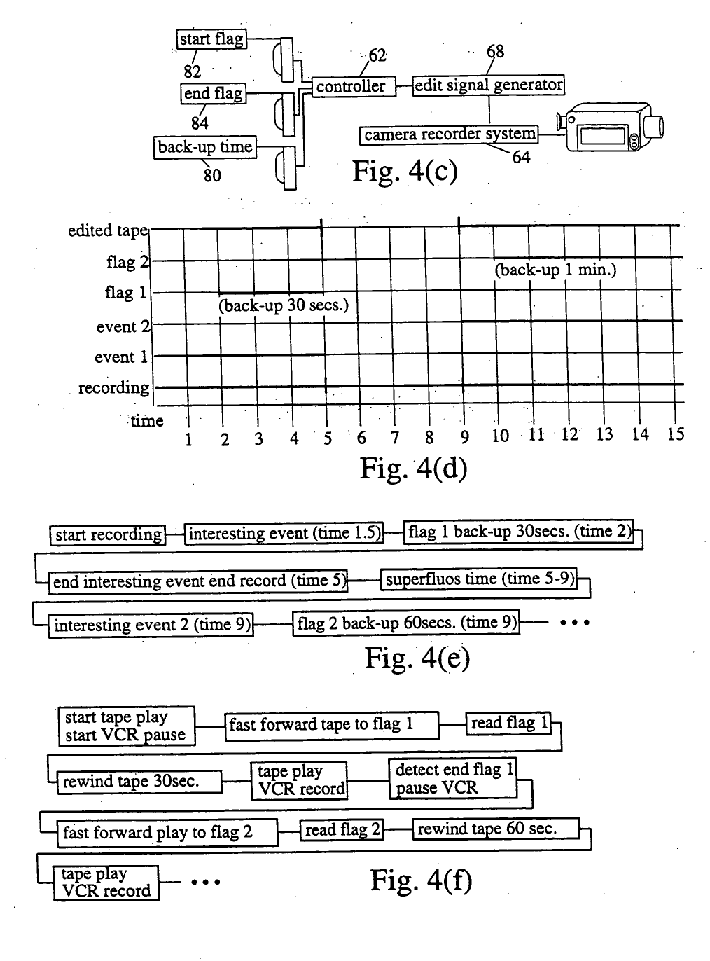

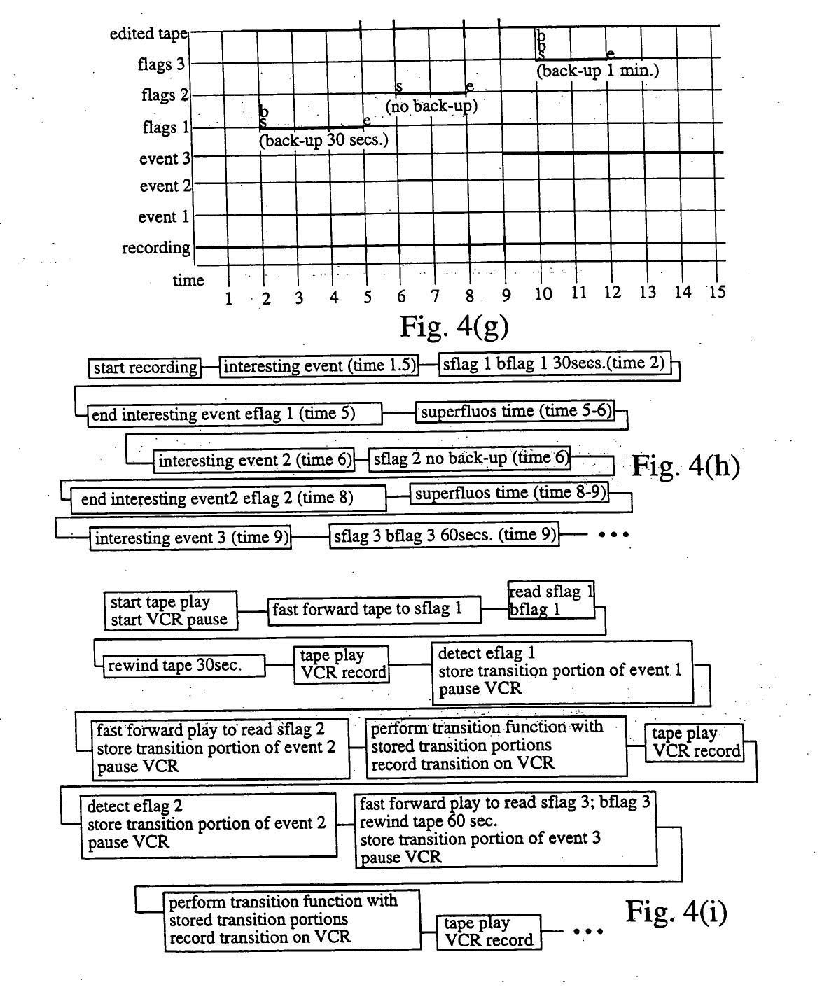

FIG. 3(a) is a perspective view of an embodiment of the present invention(s) that utilizes a record/play back system 48 of the configuration of the inventive time shifting event recorder shown, for example, in FIG. 4(b) in conjunction with a VCR 50 (or other storage device) to play back and record onto a single videotape 52 the program temporarily stored non-continuously on the two recording media 14,16. In this use, the inventive time shifting event recorder is used to play back a correctly sequenced continuous version of a recorded event for storage on a single recording means, such as a videotape 52 recorded by a VCR 50. Thus, the viewer can permanently store the recorded event for later viewing, allowing the dual recording capabilities of the inventive time shifting event recorder to be used again for controlled viewing of another program, without losing the program previously recording in a time shifting manner on the two recording media 14,16.

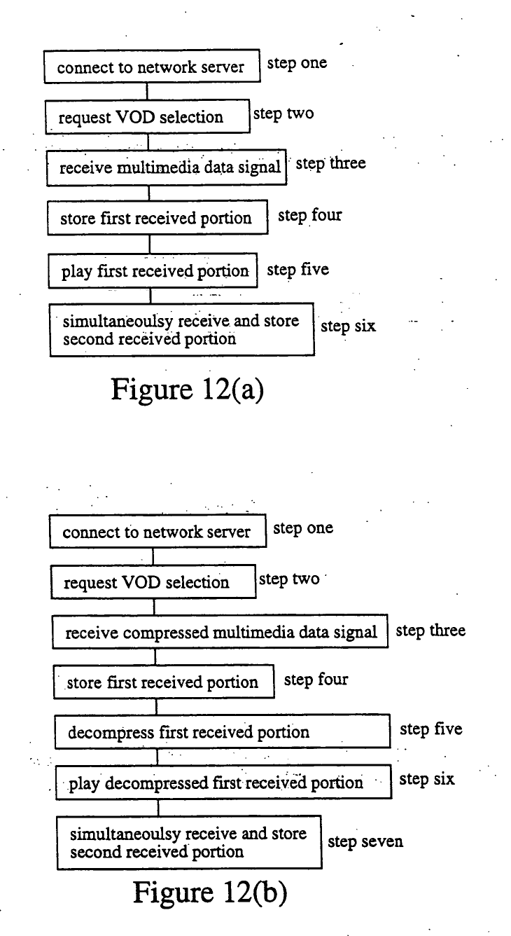

In accordance with another aspect of the present invention(s), the dual play back capability of the inventive time shifting event recorded is used for playing synchronized recordings for producing an automatically edited version of a recorded event. A recorded event is stored on at least two synchronized recorded tapes 14,16. The synchronized recorded tapes 14,16 store the recorded event captured from different respective perspectives (as described below with reference to FIGS. 12(a)-16(c)). FIG. 3(a) shows the inventive time shifting recorder and a conventional VCR 50 used to play back and record the two synchronized tapes to produce an automatically edited version containing both perspectives with synchronized timing. The video signal from both synchronized recorded tapes 14,16 is controlled (as will be described below) so that the event is recorded onto an edit-recorded tape (videotape 52) with a correct sequence. For example, the recorded event may contain a scene of dialogue between two actors. As a first alternative, a first synchronized recorded tape 14 may have a perspective of one actor, while a second synchronized recorded tape 16 may have a perspective of another actor. During play back of the scene from the two synchronized recorded tapes 14,16, the viewer can choose at any time between a variety of viewing options, such as switching between the two actors during the dialogue, or using a split screen (picture-in-picture) display of both actors, etc. For example, the first synchronized recorded tape 14 may have a perspective switching between a close-up of each actor as he speaks during the dialogue, while the second synchronized recorded tape 16 may have a perspective viewing both actors at one.

FIG. 3(b) is a perspective view of the embodiment of the present invention(s) shown in FIG. 3(a), showing user definable perspectives of the synchronized recordings played on a monitor 44. In the example given above, a first perspective 54 is obtained from a first synchronized recorded tape 14 and shows the speaking actor in the scene of dialog. A second perspective 56 is obtained from the second synchronized recorded tape 16 and shows the listening actor. The viewer can choose between the two perspectives, or as shown, can view both perspective in a split screen display. Also, a videodisk can be used to store more than one perspective since the rapid access time of the videodisk will not interfere with the continuity of the displayed recorded event. A lag time will be caused by the access to a new selected perspective (which will require searching a correct synchronization signal from the disk for the selected perspective). However, by using two or more disks, this lag time will have little or no effect on viewing. A perspective from one disk can be displayed during the search for the synchronization signal for the selected perspective from the other disk. Also, two or more read/write heads can be used to retrieve the selected perspectives from a single disk.

FIG. 3(c) is a block diagram of elements of the play back components for viewing synchronized recorded tapes 14,16. In the case of continuously played synchronized recorded tapes 14,16 (or randomly accessible disk storage), first play back means 58 and second play back means 60 are controlled by a controller 62 to generate a time synchronized video signal from the respective first and second synchronized recorded tapes 14,16. The controller 62 receives a synchronization signal recorded or otherwise associated with each of the tapes to maintain the synchronicity of the different perspectives of the recorded event. A remote signal detector 63 receives signals from a viewer-controlled remote control, and these signals are sent to the controller. The controller 62 controls switching means 61 in response to the remote signal so a selected video signal is generated. The selected video signal may include the perspective obtained from either the first and second synchronized video tape 14,16, or a combination of the perspectives in a split screen display. Also, either perspective can be fast forwarded or rewound for controlled viewing, and then re-synchronized with the other perspective at a later time by the controller 62 controlling the play back means 58,60 to fast forward, rewind, play or stop as necessary to re-synchronize the first and the second recording media 14,16.

FIG. 4(a) is a block diagram of an inventive automatic edit event recording system. In accordance with this aspect of the invention, event-recording means (camera recording system 64) records an event on a recording medium, such as a VHS, beta, or 8 mm video tape (or any other recording medium described herein). Selecting means (manual control buttons 66) is provided for selecting at least one edit-record interval corresponding to a respective selected portion of the recorded event. Signal generating means (edit signal generator 68) generates a start-record signal dependent on each selected edit-record interval. Signal recording means records each start-record signal on the recording medium. In accordance with the invention, the audio and/or video recording system of the camera (camera recording system 64) can be used to record the start-record signal onto a videotape or other recording medium. As an example, the edit signal generator 68 may generate an audio signal that contains separate start-record information for each edit-record interval. The audio signal should be above or below the range of human hearing so as not to interfere with the eventual viewing of the recorded event. The audio signal generated by the edit signal generator 68 can be sent to the camera recording system 64 to be stored on the videotape as the event is being recorded simultaneously on the same videotape by the camera recording system 64. Counter values can also be stored to determine the portions of the recorded tape that are to be later reproduced on an edit version tape. The recording of the start-record and stop-record signals produces an auto-edit signal encoded master tape from which an edit version tape can be easily made. This master tape can also be used to control a VCR so that the edited version of the event can be viewed directly from the master tape. In this case, the VCR that is playing back the master tape is controlled in accordance with the start-record and stop record signals so that the information that is viewed from the master tape corresponds the edited version of the event intended by the camcorder operator. For example, the master tape can be play-fast forwarded until the start-recording signal is detected, and then played until the stop-recording signal is detected, etc.

FIG. 4(b) is a block diagram of an inventive automatic edit play back and edited-recording system used to perform a subsequent edit-recording operation. The event recording means (i.e., camera play/fast-forward/rewind/pause system 70) performs a play back operation to play back a video/audio signal of the recorded event containing the start-record signal that is reproduced along with the play back of the recorded event. Signal detecting means 72 detects during the subsequent edit-recording operation each start-record signal from the recording medium (videotape 52). An edit controller 62 (which may be a part of or include the controller 62) controls the event-recording means (camera play/fast-forward/rewind/pause system 70) and an edited-recording means (VCR 50) during the edit-recording operation so that a play-back operation to play-back the event from the recording medium (videotape 52) is performed by the event-recording means (camera play/fast-forward/rewind/pause system 70), and a record operation to record an edited version of the event is performed by the edited-recording means (VCR 50). The edit controller 62 effectively controls the record operation during the subsequent edit-recording operation dependent on each of the detected start-record signals to record a copy of the recorded event having each said selected edit-record interval. To speed-up the time required to make the edited version, the controlling means may also includes means for controlling the event recording means (camera play/fast-forward/rewind/pause system 70) to fast forward the recording medium (videotape 52) through periods of the recorded event that are not the selected edit-record intervals (i.e., the uninteresting superfluous portions of the recorded event). The edit controller 62 controls the VCR 50 through a remote signal generator 74 that generates signals receptive by a remote signal detector 76 of the VCR 50. Since different VCRs respond to different remote signals, the remote signal generator 74 should be capable of producing different remote control signals (similar to a universal remote control).

Stated otherwise, during the recording of an event, a user of a video camera operates manual control buttons 66 to flag selected portions of the recorded event that are of interest and that should be included in a final edited version. Thus, the recorded videotape 52 contains the flagged interesting portions as well as the superfluous portions of the recorded event. During a subsequent edit-recording operation, the recorded video is played back by a play back device. The record/pause system 78 of a VCR 50 and the play/fast-forward/rewind/pause system of the play back device are controlled, so that only the flagged interesting portions of the recorded event are re-recorded onto the edited version, with the superfluous portions being automatically edited out.

FIG. 4(c) is a block diagram of an inventive automatic edit event recording system having a manual control button for selecting a beginning time of an edit-record interval. In accordance with this construction of the invention, the selecting means (manual control buttons 66) includes means for selecting a beginning time (“back-up time” button 80) of the edit-record interval. The beginning time occurs at a time prior to a time that the edit-record interval is selected (i.e., prior to depressing the “start flag” button 82). The signal generating means includes means for generating beginning time data along with the start-record signal. During a subsequent edit-recording operation, the camera play/fast-forward/rewind/pause system 70 (or other play back device) is controlled for rewinding the recorded videotape to the beginning time of the edit-record interval dependent on the start-record signal with the included beginning time data. In accordance with this feature of the invention, a user can include in a final edited version of an event, a portion of the recorded event that occurred prior to pressing the “start flag” button 82.

For example, if a user is recording a fishing expedition using a camcorder, there is no way to predict exactly when a fish will strike. To avoid including on the edited version of the event the boring superfluous wait for the fish strike, the user will not depress the “start flag” button 82 until after the fish has struck. In this case, the fish strike is not flagged for recording onto the edited version. However, by depressing the “back-up time” button 80, the start-record signal recorded on the recording medium at the time of depressing the “start flag” button 82 includes the beginning time. The amount of back-up time can be controlled to include an appropriate portion of the recorded event occurring before depressing the “start flag” button 82 so that the entire desired portion (i.e., the strike of the fish and the fight of the fish) can be automatically included in the final edited version of the recorded event. For example, depressing the “back-up time” button 80 once may include a 30 second beginning time data with the start-record signal so that the tape containing the entire recorded event is rewound 30 seconds. Each subsequent depressing of the “back-up time” button 80 may add an addition time, such as increments of 30 seconds to the amount of time that the tape is rewound. To simplify the operation, a single button can be used for both the “start flag” and the “back-up time”, in which case, the back-up time is included starting with the second depressing of a “start flag/back-up time” button. An “end flag” button 84 is depressed after the desired portion of the recorded event has been recorded.

FIG. 4(d) is a graphic illustration showing an example of a time relationship of an inventive automatic editing operation with manual beginning time selection. FIG. 4(e) is a flow diagram of an automatic edit event recording operation and FIG. 4(f) is a flow diagram of an automatic edit play back and edited-recording operation in accordance with the time relationships shown in FIG. 4(d). Referring to FIGS. 4(d) and 4(e), an entire event is recorded starting with a start recording operation. An interesting event may occur at minute 1.5. However, the user does not depress the “start flag” button 82 to record flag I (start-record signal) until minute 2. To include the beginning of the interesting event, the user depresses the “back-up time” button 80 once, and a 30 second beginning time data is included in the start-record signal of flag 1. The interesting event ends at the start of minute 5, so the user depresses the “end flag” button 84 to record the end on the selected portion of the recorded event. From minutes 5-8 the event is boring and contains superfluous uninteresting occurrences. Than, another interesting event happens at the start of minute 9, but the user does not appreciate the interest until minute 10. To include the beginning of this interesting event, the user depresses the “back-up time” button 80 twice, and a 60 second beginning time data is include in the start-record signal of flag 2.

FIGS. 4(d) and 4(f) show the operation to obtain an edited tape containing the interesting portions of the recorded event with the boring superfluous portions edited out. The camera (or other play-back device) plays the tape containing the recorded event, and a VCR 50 (or other recording device) is set to pause. The tape is fast forwarded (or played) until flag 1 is detected and read. The start-record signal of flag 1 includes the 30 second beginning time data, so the tape is rewound 30 seconds to the beginning of the first interesting event. The tape is than played and a video signal is generated by the play back device, while the VCR 50 records the first interesting event onto the edited tape. After the end of flag 1 is detected, the VCR 50 is set to pause. The tape is then fast forwarded to flag 2, which is detected and read. The start-record signal of flag 2 includes the 60 second beginning time data, so the tape is rewound 60 seconds to the beginning of the second interesting event. The tape is than played and a video signal is generated by the play back device, while the VCR 50 records the second interesting event onto the edited tape. Using this procedure, an edited tape is obtained containing only the interesting portion of the recorded event, while the superfluous boring portions of the recorded event are automatically edited out.

FIG. 4(g) is a graphic illustration showing another example of a time relationship of an inventive automatic editing operation with manual beginning time selection. FIG. 4(h) is a flow diagram of an automatic edit event recording operation and FIG. 4(i) is a flow diagram of an automatic edit play back and edited-recording operation in accordance with the time relationships shown in FIG. 4(g). Referring to FIGS. 4(g) and 4(h), an entire event is recorded starting with a start recording operation. As with the preceding example, an interesting event may occur at minute 1.5. Again, the user does not depress the “start flag” button 82 to record sflag 1 (start-record signal) until minute 2.

In this case, the start-record signal is a brief inaudible tone generated by a tone signal generator, such as the one described herein. To include the beginning of the interesting event, the user depresses the “back-up time” button 80 once, and a 30 second beginning time data (bflag 1) is included with the start-record signal of sflag 1. The bflag 1 may be, for example, another tone signal (of a different frequency or pulse) that is generated by the tone signal generated and recorded just after sflag1. The interesting event ends at the start of minute 5, so the user depresses the “end flag” button 84 to record eflag 1 along with the end of the selected portion of the recorded event. In this example, from minutes 5-6 the event is boring and contains superfluous uninteresting occurrences. Then, at minute 6 an interesting thing occurs and the user depresses the “start-flag” button 82 again to record sflag 2 (start-record signal). This time, the user does not wish to include any previous portion of the event, and so there is no back-up time data generated. This interesting event continues until minute 8, at which time the user depresses the “end flag” button 84 to record eflag 2 along with the end of the second selected portion of the event. Then, another interesting event happens at the start of minute 9, but the user does not appreciate the interest until minute 10. To include the beginning of this interesting event, the user depresses the “back-up time” button 80 twice, and a bflag 3 tone is recorded (either a single that indicates 60 seconds or two tones that indicate 30 seconds each) so that a 60 second beginning time data is include along with the start-record signal of sflag 2. Similar steps are taken throughout the recording of the event so that a master tape is obtained having all or most of the event recorded on it, and having automatic editing cues, in the form of the sflags, eflags and bflags.

FIGS. 4(g) and 4(i) show the operation to obtain an edited tape containing the interesting portions of the recorded event with the boring superfluous portions edited out. In accordance with this aspect of the invention, professional looking scene transition are automatically incorporated into the edited tape version. The camera (or other play-back device) plays the master or originally recorded tape containing the full recorded event, and a VCR 50 (or other recording device) is set to pause ready to begin recording the automatically edited version of the recorded event. The master tape is fast forwarded (or played) until sflag 1 is detected and read. The start-record signal of sflag 1(in-audible tone) is followed by bflag 1 indicating 30 second beginning time data, so the tape is rewound 30 seconds to the beginning of the first interesting event. The master tape is than played and a video signal is generated by the play back device, the VCR 50 is controlled to record the first interesting event onto the edited tape. After the eflag 1 is detected (inaudible tone indicating the end of the first interesting portion), the VCR 50 is again set to pause.

However, in order to include a professional-looking transition between the selected interesting events, the master tape is rewound just enough so that a transition portion of the first interesting event can be stored. The transition portions are the very end of a first scene and the very beginning of a second scene, and the professional-looking transition is obtained -by manipulation the recording of the transition portions onto the edited tape. For example, the transition from the first interesting event to the second interesting event may involve a “dissolve” from the very end of the first interesting event to the very beginning of the second interesting event. Many other interesting transition effects can be incorporated between scenes (selected interesting portions).

In accordance with this aspect of the invention, the transition portions of the selected interesting events can be converted (if necessary) into digital information, and then digitally stored using, for example, a RAM, or other digital information storage method. The conversion of an analog portion of the recorded event -into a digital data stream may be accomplished using, for example, using a Macintosh compatible computer that has the MOTION DC20 hardware and software installed. Macintosh computers and Macintosh system software are manufactured by Apple Computer of Copertino, Calif. and the miro Motion DC20 is manufactured by miro Computer Products AG, Braunschweig, Germany. This digital information can then be manipulated using, for example, software such as Adobe Premiere, from Adobe Systems Incorporated, Mountain View, Calif. Adobe Premiere allows for a number of different professional-looking various scene transitions including dissolves, wipes, checker board, bran door, etc.

After the transition portion of interesting event I has been stored, master tape is play fast forwarded until the next tone (sflag 2) is detected. In this example, there is no back up data recorded along with sflag 2. To produce the professional-looking transition between the first interesting event and the second interesting event, the transition portion of the recorded second interesting event must be stored. Thus, the very beginning of the second interesting event is converted into a digital data stream (if necessary) and combine using, for example, Adobe Premiere, with the stored first transition portion. The type of scene transition (dissolve, wipe, barn door, etc.) that occurs may be selected by the user or randomly generated. Once the scene transition has been generated, it is converted into an analog signal (if necessary). The VCR 50 is controlled to record and the scene transition is outputted and recorded. The rest of the second interesting event is played back from the master tape and recorded on the VCR 50. Recording of the second interesting event continues until a eflag 2 is detected. The master tape is rewound just enough so that the transition portion of the second interesting event (the very ending) can be stored. The master tape is then fast forward played until sflag 3 is detected. bflag 3 is also present just after sflag 3, and includes the 60 second beginning time data, so the master tape is rewound 60 seconds to the beginning of the second interesting event.

To produce the professional-looking transition between the second interesting event and the third interesting event, the transition portion of the recorded third interesting event must be stored. Thus, the very beginning of the third interesting event is converted into a digital data stream (if necessary) and combine using, for example, Adobe Premiere, with the stored second transition portion. Again, the type of scene transition (dissolve, wipe, barn door, etc.) that occurs may be selected by the user or randomly generated. Once the scene transition has been generated, it is converted into an analog signal (if necessary). The VCR 50 is controlled to record and the scene transition is outputted and recorded. The rest of the third interesting event is played back from the master tape and recorded on the VCR 50. Recording of the second interesting event continues until the end of the master tape or another flag is detected.

Using this procedure, an edited tape is obtained containing only the interesting portion of the recorded event, while the superfluous boring portions of the recorded event are automatically edited out. Also, in accordance with the present invention(s), the edited tape has automatically generated professional-looking transitions occurring between the selected interesting portions.

FIG. 4(j) is a flow chart illustrating the operation of recording an edited version from an auto-edit signal encoded master tape. The master tape is placed in a first cassette player (which can be the camcorder, a VCR, or the inventive multi-featured multi-media appliance 1000 described herein). The blank edit version tape is place in a second cassette player (which, again, can be the camcorder, a VCR, or the inventive multi-featured multi-media appliance 1000 described herein). The start of the master tape is played (step one), and play continues (step two) until a start flag is detected (step three). If a start-flag is detected (step three), then it is determined if back-up data is detected (step four). If back-up data is detected (step five) then the master tape is rewound in accordance with the back-up data (step five). The information on the master tape is then recorded onto the edit version tape (step six). The recording continues until an end flag is detected (step seven), or the end of the master tape is detected (step eight). If the end flag is detected (step seven), then the recording of the edit version tape is paused (step nine) and control goes to step two. If the end of the master tape is detected, then the recording of the edit version tape stops (step ten).

FIG. 4(k) is a flow chart illustrating the operation of recording an analog edited version from an analog auto-edit signal encoded master tape wherein a digital recording medium is used to temporally store the edited version tape. This algorithm illustrates how an inventive multi-featured multi-media appliance 1000 that include, for example, a computer hard drive, can be used with an existing VCR to produce an edited version tape from a master tape. Alternatively, the multi-featured multi-media appliance 1000 can include a computer hard drive and a video cassette tape drive. In accordance with this aspect of the invention, the master tape is placed in a first cassette player (which can be the camcorder, a VCR, or the inventive multi-featured multi-media appliance 1000 described herein). The start of the master tape is played (step one), and play continues (step two) until a start flag is detected (step three). If a start-flag is detected (step three), then it is determined if back-up data is detected (step four). If back-up data is detected (step five) then the master tape is rewound in accordance with the back-up data (step five). The information on the master tape is then converted from analog video data to digital video data (step six) and recorded onto the digital recording medium (step seven). The recording continues until an end flag is detected (step eight), or the end of the master tape is detected (step nine). If the end flag is detected (step eight), then the analog to digital conversion is paused (step ten) and the digital recording is paused (step eleven) and control goes to step two. If the end of the master tape is detected, then the digital recording stops (step twelve). Once the edited version of the event has been digitally recorded, the master tape is removed from the cassette, and the blank edit version tape is place in the cassette (which, again, can be the camcorder, a VCR, or the inventive multi-featured multi-media appliance 1000 described herein) (step thirteen). Alternatively, if it is not desired to keep the original master tape with the superfluous recorded portions, then the master tape can simply be rewound and recorded over (step thirteen). The playback of the digital version of the edited version of the event begins (step fourteen) and continues (step fifteen). The playback of the digital version includes converting the digital video data to analog video data (step sixteen) so that is can be recorded on the blank edit version tape (step seventeen). The playback and recording continues until the end of the recorded digital video data is reached (step eighteen), after which the VCR recording of the edited version stops (step nineteen). By this algorithm, only one VCR deck is needed to perform the auto-editing features of the present invention(s).

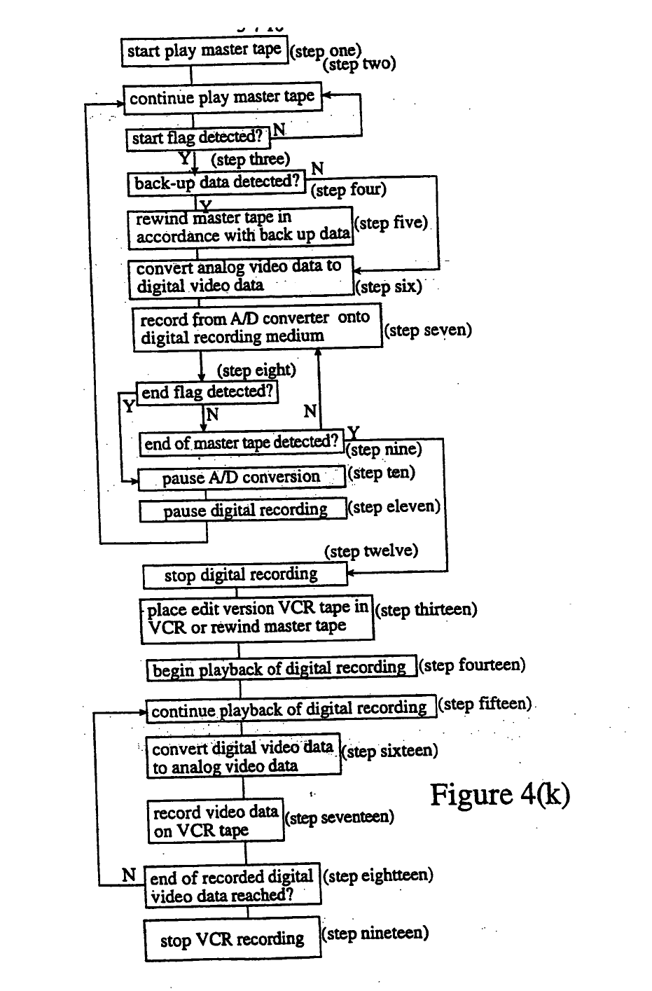

As shown in FIG. 5, the various inventive features described herein can be incorporated within a multi-featured multi-media convergence appliance 1000. Such a device may include the components necessary to enable one or more of the inventive aspects described above. For example, recording means and other components shown, for example, in FIG. 1(a) can be included to enable the time-shifting operations described herein. The inventive multi-featured multi-media convergence appliance 1000 can include a modem 47 for receiving and sending data to a computer network such as the Internet to perform the Internet and network operations described herein. The receiving means 12 and a camcorder can include jacks 51 to exchange the audio and video signals to/from the camcorder or other video playback device to perform the auto-editing playback functions described herein. The inventive multi-featured multi-media convergence appliance Some or all of the auto-edit circuitry 49 can be incorporated onboard the camcorder, or some or all of the auto-edit circuitry 49 can be incorporated in the inventive Multi-featured multi-media convergence appliance 1000 (this is represented by the dashed line connecting the controlling means 24 with the auto-edit circuitry 49. For example, the determining means 23 (start-recording value detecting means 27 and stop recording value detecting means 29) can be utilized to detect the auto-edit signals. The controlling means 24 is responsive to the determining means 23 to control the rewinding/pausing/playback/fastforward operations of the source video tape and control the record/pause operations of the edited version video tape. The source video tape can be encoded with information that determines the edited version of the recorded event. The information can be a counter value, audio signal, video signal, or other identifying information that is used to trigger the appropriate control operations of the controlling means 24. The source video tape can be played back from one of the recording means, a VCR or the camcorder, and the edited tape can be recorded using one of the recording mediums, a VCR or the camcorder. The control of the VCR or the camcorder can be done through remote control signals generated by the remote signal generator 74, or through a direct connection with the inventive Multi-featured multi-media convergence appliance 1000.

Video cassette recorders (VCRs) are well known. Prior to the VCR, television viewers were forced to watch television programs in a synchronous manner, that is, in order to watch a television show a viewer had to synchronize his or her schedule to the time that the show was broadcast. Every viewer of a particular broadcast television show watched the show at the exact same time as every other viewer. With the advent of the VCR, viewers are free to watch a broadcast television show asynchronously. That is, the viewer can set their VCR to record a show, and only after the entire show has been recorded can playback the show with viewer determined pauses and replays.

In accordance with the present invention, a multi-featured multi-media appliance 1000 is provided that overcomes the drawbacks of the conventional art. The multi-featured multi-media appliance 1000 can be configured to allow viewer determined pauses and replays at any time during the broadcast of a television show, and the viewer is able to watch the entire show. With the inventive multi-featured multi-media appliance 1000, a viewer can pause the display of, for example a television program, at any time and for any length of time (limited by the recording capacity of the recording media). The pause can take place while the program is being aired, and the viewer can return to viewing the program from the point where the pause began, even while the program continues to be received. During the pause the viewer may replay a previously recorded portion of the program, fast forward through a recorded portion, or simply take a break from viewing and switch to another channel. Also, the present invention allows a viewer to pause the display of a program and switch to another media system, such as an Internet connection. The viewer can access information from the Internet computer network while pausing the display of a television program. Once the viewer has reviewed the computer network site, he can return to the television program without missing any of it.

In accordance with the present invention, a time sequential signal is received by receiving means 12, such as an antenna, cable television set top box, modem, etc. The time sequential signal contains an information stream, such as a television program, Internet or Intercast web pages, and/or a radio program. The information is displayed on displaying means 44, for example, on a television or computer monitor.

In accordance with the present invention a viewer can take an arbitrary pause during the viewing of the information. The information can be, for example, a broadcast television program displayed on a television set, or blanking interval information such as an Intercast web page or Internet hyperlink included in a broadcast (or multicast) program signal, or a radio program, or other information stream. The viewer inputs a pause display command using, for example, a remote controller that sends a radio or infrared signal to input receiving means 32. When the pause display command is received, recording means 14 is used to record a beginning of a first recorded portion of the time sequential signal on a first recording medium 16. The part of the time sequential signal that is received during the pause is recorded on the first recording medium 16 for the duration of the viewer-determined pause.

When the viewer desires to continue watching the television program, the remote controller is used to send a resume display command, which is received by the input receiving means 32. When the resume display command is received, the ending of the first recorded portion of the timesequential signal is recorded on the first recording medium 16.

In order for the viewer to watch the portion of the program that was received during the pause, the beginning of the first recorded portion is first determined, and the first recorded portion of the time sequential signal is then played back.

To enable the viewer to watch all of the program, that part of the time sequential signal that is received while the first recorded portion is being played back must also be recorded.

Thus, in accordance with the present invention, a second recorded portion of a different part of the time sequential signal is recorded on a second recording medium 22. The second recorded portion is a different part of the time sequential signal than the first recorded portion of the time sequential signal, since it contains the segment of the program that is received while the first recorded segment of the program is being played back. Of course, the first recorded portion contains the segment of the program that was received when the viewer took the pause. Thus, in accordance with the present invention, the playing back of the first recorded portion of the time sequential signal and the recording of the second recorded portion take place.

It is determined if the ending of the first recorded portion has been played back. If the ending of the first recorded portion has not been played back, then playing back of the first recorded portion of the time sequential signal continues while simultaneously recording the second recorded portion of the time sequential signal. If the ending of the first recorded portion has been played back, then an ending of the second recorded portion of the time sequential signal is recorded on the second recording medium, the beginning of the second recorded portion is determined, and then the second recorded portion of the time sequential signal is played back.

In accordance with the present invention, what is played back (the first recorded portion) and what is recorded (the second recorded portion) are not the same, in the case of a television program, they are different segments of the program. The above-described recording and playing back scheme provides a method and apparatus that allows a user to arbitrarily pause the received program, or other information stream, and still view the program in its entirety.

The beginning of the first recorded portion is determined by setting a first start-recording value when the pause display command is received. This start-recording value is later used to determine where to start the playback of the recorded portion. When the pause display command is received, the determining means 23 makes an indication of the physical or electronic location of the beginning of the recorded portion. This indication (start-recording value) is used for finding where each recorded portion begins. The physical location of the beginning of each recorded portion may be, for example, a segment of a recording tape, or a sector and/or track of a recording disk, etc. The electronic location may be an address of a memory circuit, etc. The mechanism employed to set the start-recording value depends on the type of recording medium that is used. For example, if the recording medium is a magnetic tape, such as a VCR cassette, then the start-recording value can be set by generating and recording a tone signal. If the recording medium is a computer diskette or hard drive, then the start-recording value can be set by storing a disk location value in a file allocation table. A digital counter can be used to set the start-recording value-by noting and storing the counter value when recording the beginning of the first recorded portion of the time sequential signal. A memory address can also be stored to set the start recording value if the recording medium is an electronic memory device such as a RAM. As another alternative, the physical location of the beginning of the first recorded portion can be predetermined. These same techniques can be employed for setting second and subsequent start-recording values, as well as for setting stop-recording values. In accordance with the present invention, the determining means 23 may include stop-recording value setting means 31 for setting a stop recording value. The stop-recording value indicates where the end of each recorded portion of the time sequential signal is located on the recording medium. The stop-recording value is used to determine the end of a recorded portion of the time sequential signal.

As the viewer watches the first recorded portion of the program played back from the first recording medium 16, the second recorded portion is recorded on the second recording medium 22. If the ending of the first recorded portion has not been played back, then playing back of the first recorded portion of the time sequential signal continues while the second recorded portion of the time sequential signal is recorded. The ending of the first recorded portion is determined by detecting the stop-recording value, which, as discussed above, may be a tone signal, a counter value, a physical location (such as a location on a disk stored in a file allocation table), etc.

When the ending of the first recorded portion has been played back (as determined by detecting the first set stop-recording value), then an ending of the second recorded portion of the time sequential signal is recorded on the second recording medium, and a second stop-recording value is set. -The beginning of the second recorded portion is then determined using the second start-recording value, and then playback of the second recorded portion of the time sequential signal begins. Thus, the second recorded portion of the time sequential signal contains that part of the program that is received while the first recorded portion is being played back and playing back the second recorded portion enables the viewer to view the entire program without missing any of it.

Further, if the viewer wishes to re-watch a segment of the program then a viewer selected function (for example, rewind) is transmitted from the remote control to the input receiving means 32. After rewinding the recording medium (in the case of a VCR tape) or going to a previously viewed disk location (in the case of a hard drive, DVD, or other disk media) another viewer selected function (for example, play) can be transmitted. The segment that is rewound can then be watched again. Further, the viewer can fast forward through boring portions, or through commercials, and may be able to “catch up” with the reception of the time sequential signal so that the program can be again viewed as it is received. The viewer may also pause the viewing of the recorded portion of the program. In any event, as the viewer selected function(s) is performed, the time sequential signal still continues to be recorded as it is received so that the entire program can be watched at the viewer's leisure.

In accordance with the present invention, a time sequential signal is received via, for example, an antenna, a cable television hook up, Internet modem connection, satellite transmission or other information transfer mechanism. The information depending on the time sequential signal is displayed for viewing on a television, computer monitor, radio, or other displaying device 44. The information that is displayed may be a television or radio program, or received data from a computer network, such as the Internet. The present invention enables asynchronous viewing of a multicasted or broadcasted television program in conjunction with the perusal at the viewer's leisure of computer network information, such as a world wide web page downloaded from the Internet. The present invention allows a viewer to pause the display of a program and switch to another media system, such as an Internet connection. The viewer can access information from the Internet computer network while pausing the display of a television program.

The time sequential signal may be a television program which contains a blanking interval (a portion of the video signal that is received during a time when the video display scanning returns to the top of the screen). The blanking interval can include blanking interval -information including a selectable link, such as a network address, to network information, such as a world wide web page, from a computer network, such as the Internet. The television program is displayed before receiving the pause display command. When the viewer wishes to obtain information via the Internet, the viewing of the television program is paused and the computer network is accessed using a modem or other suitable accessing means. The network information that is addressed by the selectable link is received from the computer network. This network information is displayed while the viewing of the television program is paused and time sequential signal is recorded so that the program viewing can be returned to at a later time without missing any of the program.

The inventive multi-featured multi-media appliance 1000 can display a received television commercial 144 having an Internet address automatically linked by a hypertext message 146. Viewing of the paused program can continue in the time shifted manner described herein after the viewer returns from the Internet session.

Program information can be retrieved from the Internet, the television signal, or other medium, and displayed for the user during the operation of the inventive multi-featured multi-media appliance 1000. The program information can be searched to select specific shows that are of interest to the user and then program information for the selected shows can be downloaded or otherwise retrieved to enable the inventive multi-featured multi-media appliance 1000 to provide easy VCR or video recording capabilities.

The inventive multi-featured multi-media appliance 1000 can be configured to selectively restrict the reception of television and data content that a parent or care-giver decides in inappropriate for viewing by children. The content available to the user can be rated in accordance with a collaborative consensus of the user's of the computer network and/or television system.

The inventive Internet/television convergence appliance can be used to program a VCR via downloaded VCR control information received from an Internet source, a disk or tape mailed to the user or through the television signal. The downloaded VCR control information can be used to control recording on one or more of the recording mediums incorporated in the inventive multi-featured multi-media appliance 1000. The inventive Internet/television convergence appliance 1000 can incorporate components 53 such as a television tuner, computer hard drive, video card and/or frame grabber and printer port. Other peripheral components can also be included to enhance the usefulness of the inventive Internet/television convergence appliance. For example, the peripheral components may include a speaker phone, answering machine, radio tuner or remote home wiring control circuitry.

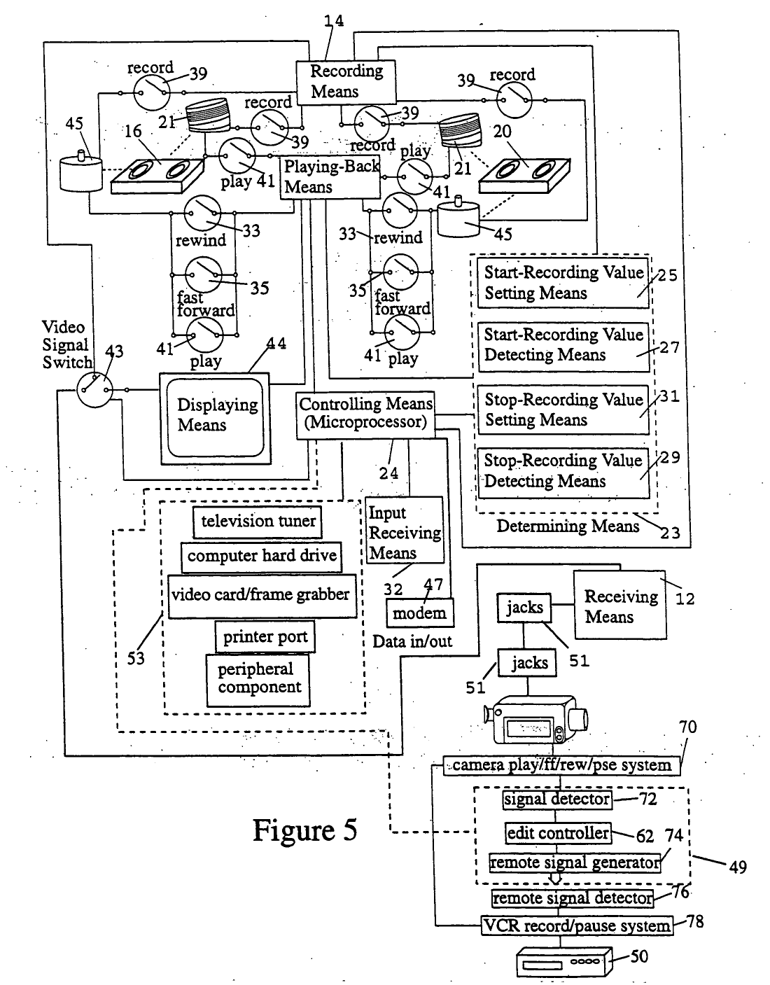

FIGS. 6(a) through 6(b) show the configuration of the first and second recording medium 16 and 22 of the inventive time shifting event recorder shown, for example, in FIG. 1(a). In this case, the first recording medium 16 comprises at least one portion of a recordable disk and the second recording medium 22 comprises at least one other portion of the same recordable disk. Read/write heads of the respective recording means is able to retrieve and write information on different portions of the same recordable disk simultaneously. Thus, a single recordable disk is used as the recording medium for both the first and second recording medium 20. As shown in FIG. 6(a), the recordable disk is recorded on one side thereof by both read/write heads 38 of the respective recording means. FIG. 6(b), on the other hand, shows a configuration in which the disk recording medium is recorded on both sides thereof. In this case, the read/write head 38 of one of the recording means records on one side while the read/write head 38 of another of the recording means records on the other. It is noted that if a third or more recording means is utilized, then another read/write head 38 may be used to record and play back information from different portions of the disk recording means. In the case of the memory circuit, the idea is the same. Namely, each recording means records the respective portions of the time sequential signal at, for example, different address locations of the memory circuit and these locations are addressed to retrieve the stored information. The disks can be stacked, or otherwise configured to increase the storage capacity. Nearly any configuration suitable for recording video signals can be used, so long as the recording and playback of information can occur simultaneously. Buffers can be used so that, for example, the video data can be compressed and expanded as necessary.

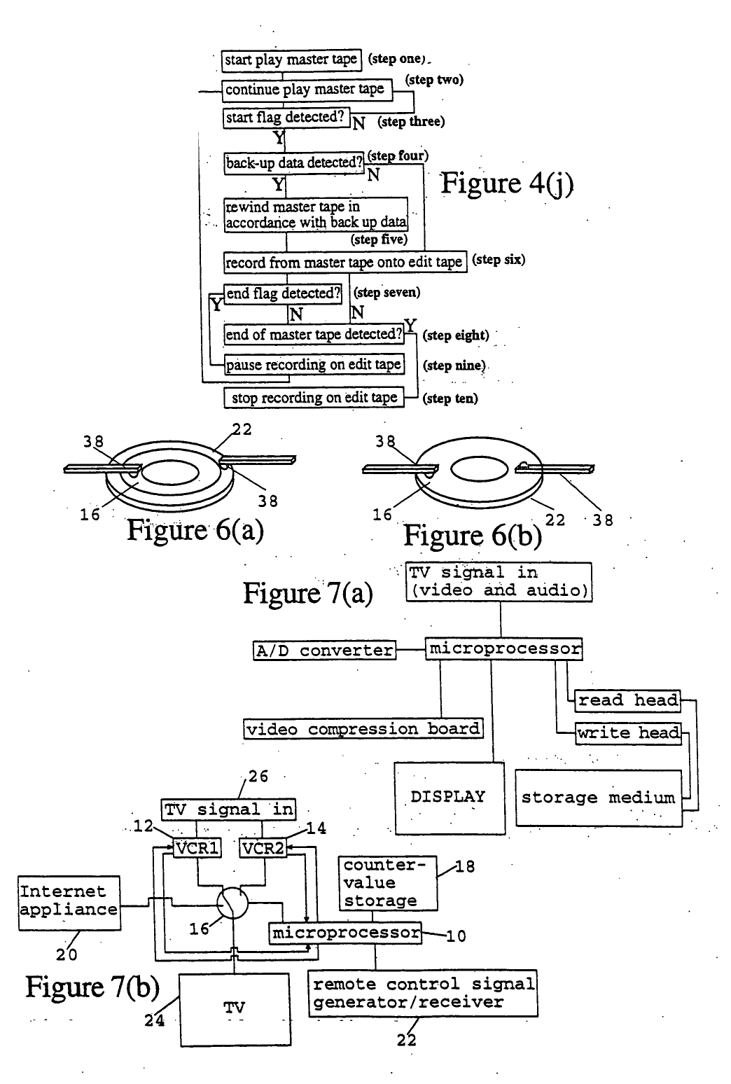

The following is an illustration of a specific embodiment of the inventive time shifting event recorder. It is noted that this embodiment illustrates only one of many configurations for the inventions, as described herein. FIG. 7 shows a block diagram of a configuration of the inventive time shifting event recorder for arbitrarily pausing the display of a video signal, such as a television program. The system components of this configuration includes a microprocessor 10 and electronic circuitry that controls the operation of a first VCR (VCR1 12), a second VCR (VCR2 14), a video signal switch 16, and a data storage device 18. An Internet appliance 20, along the lines of WebTV, may be provided to enable access to the Internet and on-line services during the user-determined pauses made possible by the inventive time shifting event recorder. Access to the Internet and on-line services is accomplished via modem or other data transfer devices. Also, a universal-type remote control signal generator and/or receiver 22 may be included to send control signals to the components and to receive user input in the form of wireless remote control signal. Further, depending on the configuration of the inventive system, the data can be transferred between the microprocessor 10 and the other components using a high speed transfer system such as that specified as IEEE 1394 also known as “FireWire”. The video information and Internet data is displayed on a television 24.

The first and second VCR drives (VCR1, VCR2 12,14) may be separate video cassette recorder units, or may be combined in a single dual-deck video cassette recorder. The microprocessor 10 may include some of the peripheral devices such as the data storage device 18, and additional electronic components may be required to implement the control of the inventive time shifting event recorder in the manner described herein.

The control of the VCRs 12,14, video signal switch 16, television 24 and/or Internet appliance 20, and the reception of data from the devices may be accomplished by direct wiring. For example, the electronic circuit included in the VCR that drives the display showing the counter-value may be directly connected via wires to the microprocessor 10. Alternatively, remote control signals generated by the remote control signal generator and/or receiver 22 can be used to enable the microprocessor 10 to control the operation of the system components. Additional circuitry may be included to enable split screens or picture-in-a-picture display of, for example, user-determined instant replays, Internet content and the like. The television signal can be received through an antenna, co-axial cable, satellite dish or any other means for receiving TV signals (as illustrated by block “TV signal in” 26).

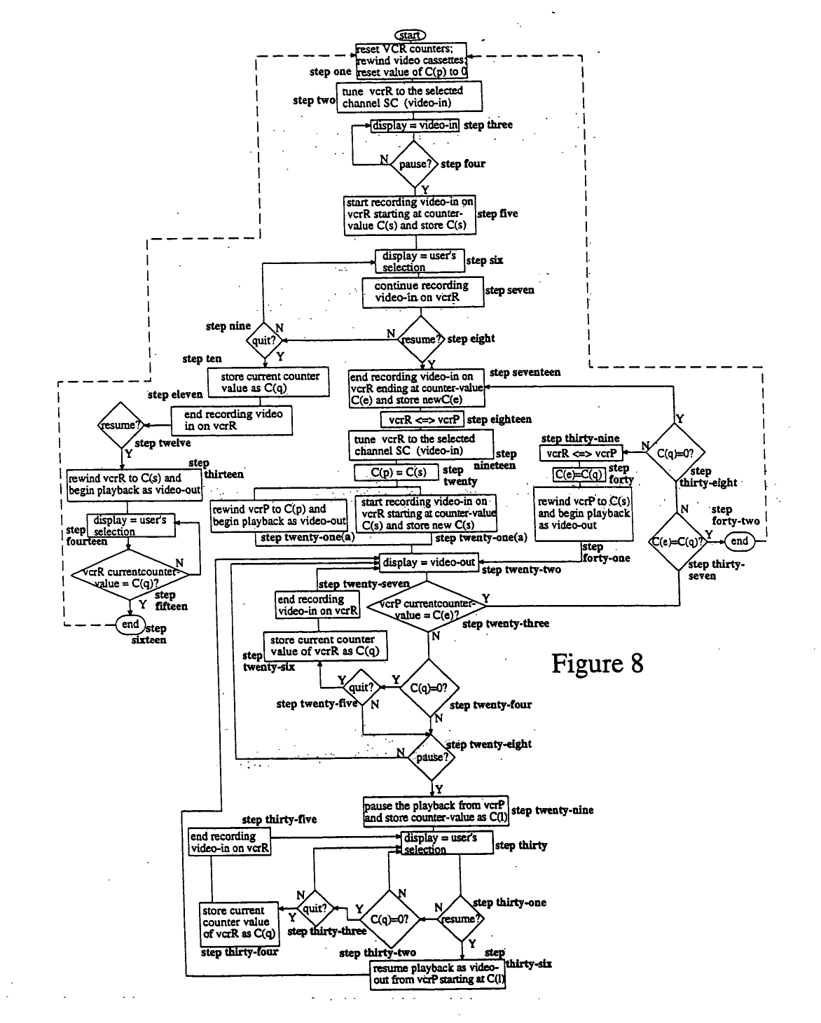

FIG. 8 shows a flowchart of an algorithm showing the operational steps of the configuration of the inventive time shifting event recorder shown in FIG. 7. This algorithm demonstrates a time shifting event recorder comprised of two conventional VCRs (VCR1 12 and VCR2 14) controlled by a microprocessor 10 circuit, however, as discussed at length herein other configurations are possible all falling within the scope of the invention. Before the time shifting operation, the tape counters of each of the VCRs 12,14 can be reset so the counter-value at the start of recording is 00:00:00. In addition to resetting the counter values, the video cassette of each VCR can be rewound to its beginning prior to resetting the tape counters. Further, the stored value C(q), the counter-value of the recording VCR when a quit command is received, is reset to a value of 0 (step 1).

In accordance with this configuration, at least one of the VCRs 12,14 (vcrR) is tuned to the selected channel SC and receives the television program as video-in (step 2). As will be described, the present invention enables the user to arbitrarily pause the reception of this television program at any time, and for any length of time, limited only by the recording capacity of the VCRs 12,14. As an optional step, both VCRs can be initially tuned to the same television channel on which is carried the television program that is being viewed by the user, then one of the VCRs (not vcrR) can begin recording at the onset of the program so that even portions of the program that are viewed before the user-determined pause can be replayed.

The television signal is received through the VCR1 12 (vcrR) as video-in (step two) and the video signal switch 16 is controlled by the microprocessor 10 so that the program is displayed on the television 24 in real time (step three). The microprocessor 10 waits for a pause command to be inputted by the user (step four). As long as the pause command is not received (N; step four), the video-in is displayed (step three) so that the television program continues to be displayed as it is received (real-time). If the user wishes to view a user-determined instant replay, or engage in an Internet session, or channel surf, or simply take a viewing break, then a pause command is inputted (via a remote controller) and the microprocessor 10 controls the video signal switch 16 and the VCRs 12,14 and/or Internet appliance 20 in accordance with the viewing selection of the user.

For example, if the user wishes to begin an Internet session, the microprocessor 10 controls the Internet appliance 20 so that a connection with the Internet is made. During the time it takes for the connection to be made and the Internet session to begin, the program may continue to be viewed. For example, it can be detected when the home page of the Internet browser used by the Internet appliance 20 is loaded or is being loaded, and then the microprocessor can control the video signal switch 16 so that the signal from the Internet appliance is then displayed. The time shifting recording operations on vcrR can begin at the onset of the user's input to begin the Internet session so that the portion of the program that is received while the Internet connection is being made is available for later viewing. If the program continues to be viewed while the connection is being made, then counter-value C(s) (described below) can be determined when the video signal switch 16 switches from television program to the Internet session (to avoid redundant viewing of the program).

In any event, when the user inputs the pause command (Y; step four), then recording of the video-in begins on vcrR starting at the counter-value C(s) (step five) (unless modified as described in the preceding paragraph). The counter-value C(s) can be predetermined by resetting vcrR's counter to 0:00:00 (i.e., step one), or the current counter-value can be detected. The counter-value C(s) is sent to the microprocessor 10 via a wire link, or through an infrared or other remote data transmitter (if the counter-value 0:00:00 is used, the microprocessor 10 sends an appropriate signal to the vcrR so that the counter is reset) if it was not reset in step one. The counter-value C(s) is stored by the microprocessor 10 in the counter-value storage device 18 so that the location of the beginning of this portion of the recorded video-in can later be determined. The microprocessor 10 controls vcrR to record the received television signal (video-in) during the user-determined pause. The control of the VCRs 12,14, video signal switch 16 and/or Internet appliance 20 can be done via wire links, or through an infrared or other remote data transmitter. For example, to increase the versatility of the invention, the control of the VCRs 12,14 can be accomplished using circuitry similar to a commercially available “universal” remote controller.

During the user-determined pause, the user can access the Internet via an Internet appliance 20 such as WebTV. The television signal that carries the program can also include hyper-links to related Internet content. For example, a TV commercial may include a hyper-link to the advertiser's Web site. At the user's option, the hyperlink can be activated resulting in the retrieval of information from the Internet. Once the connection is established and the desired Web site is ready for display, the “pausing” of the program occurs in the manner described herein.

Once the pause command is received by the microprocessor 10, the video signal switch 20 is controlled so that the display on the TV 24 is in accordance with the user's selection (step six). If recording begins at the start of the program on VCR2 14 (even though it is viewed in real-time), the user may also engage in user-determined instant replays by rewinding and replaying a portion of the recorded video-in that was received prior to the pause (step six). In this case, the microprocessor 10 controls the video signal switch 16 so that the output of the VCR2 14 containing the “instant replay” recording is displayed on the TV 24 while video-in is recorded on vcrR (VCR1 12). During the pause, the microprocessor 10 can control the video signal switch 16 so that the video signal from the Internet appliance 20 is displayed on the TV 24 (if the user chooses to access the Internet). The microprocessor 10 can control the video signal switch 16 so that the video signal from the VCR2 14 is displayed on the TV 24. In this case, the television program that is being recorded is tuned in by vcrR (VCR1 12) while the tuner of the other VCR (VCR2 14) can be used for channel surfing.

The recording of the video-in (television program) continues (step seven) while the microprocessor 10 waits for the user-inputted resume command (step eight) and controls the various devices (VCRs 12,14; Internet appliance 20; video signal switch 16, etc.) in accordance with the user's selections.

During the recording of the television program, the existence of television commercials can be detected by detecting the information that is included in the vertical blanking interval (VBI) of the television signal. Recording of the television commercials can be prevented by sending a record-pause signal from the microprocessor 10 to vcrR when the beginning of a commercial break is detected, and then sending a record-resume signal from the microprocessor 10 to the vcrR when the commercial break ends.

If the resume command is not inputted (N; step eight), then it is determined if a quit command has been inputted (step nine). As long as no resume command (step eight) or quit command (step nine) is received, the video signal switch 16 is controlled to display the user's selection and recording of video-in on vcrR continues (step seven).

The quit command can be generated by a remote controller under the control of the user. Alternatively, the quit command (or other control command, such as to initiate and control an Internet session) can be generated in response to a information embedded in the television signal. For example, if the quit command is included in information embedded at the end of the television program, it can be detected and used (as described herein) by the microprocessor 10 to determine when to stop recording the television program.

If the quit command is received before the first resume command (Y; step nine), then the current counter-value of vcrR is stored as C(q) in the counter-value storage device 18 (step ten) and the microprocessor 10 controls vcrR to end recording video-in (step eleven). Once the resume command is inputted (Y; step twelve) the vcrR is controlled by the microprocessor 10 to rewind back to counter-value C(s) and begin playback of the recorded portion of the TV program as video-out (step thirteen). To save time, the rewind operation can begin as soon as the recording ends (step eleven). The VCRs 12,14, Internet appliance 20 and video signal switch 16 are controlled according to the user's selection so that the user's selection is displayed. For example, if the user's selection is to engage in an Internet session, then the playback from vcrR is paused and the video signal switch 16 is controlled so that the signal from the Internet appliance 20 is displayed.

Once the current counter-value of vcrR equals C(q) (step fifteen) the portion of the program-recorded prior to the quit command has been played back and the time shifting recording operation ends (step sixteen).

When the resume command is received (Y; step eight), then the recording of video-in on vcrR ends at counter-value C(e) (step seventeen). Thus, the location of the cassette tape that contains the just-recorded portion of the TV program is defined by the end points determined by values C(s) and C(e). The counter-values C(s),C(e) can be obtained by taping into the wiring of the VCR that drives the display that shows the counter value. The value of C(e) is stored by the microprocessor 10 so that the location of the ending of the recorded video-in can later be determined. The resume command can be inputted automatically from an Internet site so that when the user has come to the end of related information contained on the Internet site a command is sent from the site to the user's Internet appliance 20 that in turn sends the resume command to the microprocessor 10.

Once the resume command is received, the microprocessor 10 controls the VCRs 12, 14 so that the recording VCR, (vcrR; now VCR1 12) becomes the playback VCR (vcrp) and the playback VCR (vcrP; now VCR2 14) becomes the recording VCR (vcrR) (step eighteen). Thus, in the first iteration of the loop vcrR changes from VCR1 12 to VCR2 14, and vcrP changes from VCR2 14 to VCR1 12.

The portion of the television signal that is received during the playback of the portion that was received during the pause is recorded so that it can be later viewed. If it is not already so tuned, vcrR is tuned to the selected channel SC to receive the television program (video-in) (step nineteen). In accordance with this embodiment of the invention, the microprocessor 10 re-stores the value of C(s) as C(p) and set C(s) to the counter-value at which recording begins on vcrR (now, VCR2 14) (step twenty).

In this case, the data storage device needs to have enough capacity to store at least the five counter-values, C(s), C(e), C(p), C(l) and C(q). The microprocessor 10 retrieves the value of C(p) (formerly, C(s)) and vcrP is rewound to counter-value C(s) (the beginning of the portion received during the pause). The microprocessor 10 sends control signals to vcrP to rewind the cassette until counter-value C(p) is detected (indicating the beginning of the just-recorded portion of the TV program. Then once counter-value C(p) is reached, vcrP is control to begin playing back the just recorded portion as video-out (step twenty-one(a)).

At the same time that vcrP is being controlled to rewind to counter-value C(p), vcrR (now, VCR2 14) is controlled to begin recording the video-in (television program) starting at counter-value C(s), and C(s) is stored by the microprocessor 10 (or the counter of VCR2 14 is reset to 0:00:00) (step twenty-one(b)). Alternatively, the VCR's counter can be reset to 00:00:00, and C(s) preset to equal 00:00:00.

After the first iteration of the loop, when recording video-in on vcrR the cassette of vcrR can be rewound, if necessary, so that the counter-value is again 00:00:00. However, during the time that the cassette is rewinding, the television program will not be recorded. Therefore, it may be preferable to either modify the cassette so that the time for rewinding is relatively short, or simply to forego the rewinding operation unless the end of the tape is reached. If the cassette is to be modified, the take-up and supply reels of the cassette can be constructed so that the supply reel is relatively larger than the take up reel. Thus, each revolution of the supply reel (when it is driven in reverse during the rewind process) will replace more tape back onto the supply reel than if both reels were of equal diameter.

The microprocessor 10 switches the video signal switch 16 so that the played back video-out is displayed (step twenty-two) on the TV 24 and the user views the portion of the television program that was received during the pause. While the video-out is played back from vcrP, the video-in continues to be recorded on vcrR. The microprocessor 10 waits for either the end of video-out (step twenty-three) or another user-inputted pause command (step twenty-five or step twenty-eight).

The end of video-out is determined by detecting when counter-value C(e) is reached on vcrP. Thus, the microprocessor 10 compares the current counter-value of vcrP with the stored value C(e). When the current counter-value equals the stored value C(e), then the end of video-out (for this recorded portion of the program) has been reached (Y; step twenty-three). If the end of video-out is not reached (N; step twenty-three), the microprocessor 10 determines if the stored value C(q) is equal to 0 (step twenty-four). In step one, C(q) is reset to 0, and it does not change from 0 unless the a quit command is received. Thus, if C(q) is equal to 0 (Y; step twenty-four), the quit command has not yet been received, and it is determined if a command has been inputted that equals the quit command (step twenty-five). If the quit command has been inputted (Y; step twenty-five) then the current counter-value of vcrR is stored as C(q) (step twenty-six) and the recording of video-in on vcrR ends (step twenty-seven). Control then goes back to step twenty-two and the video-out continues to be displayed without the recording of video-in onto vcrR.

If the quit command is not inputted (N; step twenty-five), then it is determined if a pause command is inputted (step twenty-eight). If the pause command is not received (N; step twenty-eight), the display of video-out (recorded show portion) from vcrP and the recording of video-in (received show portion) onto vcrR continues.

The user may take any number of pauses during the time-shifted viewing of the television program. When the user inputs a pause command (Y; step twenty-eight), the playback of video-out from vcrP is paused and the current counter-value can be stored as C(l) by the microprocessor 10 (step twenty-nine). The counter-value C(l) is stored as a marker for the end of the played-back portion of the time-shifted television program so that play back can be picked up where it left off. During the pause, the last frame of video-out, the real time program or a blank screen can be displayed, or the user can access the Internet, watch a user-determined instant-replay or channel surf.

While the viewing pause is occurring, the video-in (received television program) continues to be recorded on vcrR and the user's selection is displayed (step thirty). The microprocessor 10 waits for an inputted resume command (step thirty-one). If the resume command is not received (N; step twenty), it is determined if the stored value C(q) is equal to 0. If C(q) is not equal to 0, then the quit command has already been entered. In this case, control goes immediately back to step thirty and the user's selection continues to be displayed.

Again, if C(q) is equal to 0, then the quit command has not yet been entered. In this case, it is determined if the quit command is inputted. If it not (N; step thirty-three), then the video signal switch 16 is controlled so the user's viewing selection is displayed on the TV 24 (step thirty) while the incoming television program is recorded on vcrR (step nineteen). If the quit command is inputted (Y; step thirty-three) then the current counter-value of vcrR is stored as C(q) (step thirty-four) and the recording of video-in on vcrR ends (step thirty-five). Control then goes back to step twenty-nine and the video-out continues to be displayed without the recording of video-in onto vcrR.

When the resume command is received (Y; step thirty-one), then the playback of the video-out begins again from vcrP starting at counter-value C(l) (step thirty-six). Thus, when the user wishes to begin viewing the program again (or at a time dictated by, for example, a response to a web page), a resume command is inputted. The stream of video information is retrieved from the vcrP starting at the last portion of the recorded video that was displayed (counter-value C(l)).

Control then goes to step twenty-two, and the video-out from vcrP is displayed until the current counter-value of vcrP is equal to the stored value C(e) indicating that the end of the recorded portion on vcrP is reached (step twenty-three), another pause command is received (step twenty-eight), or if it has not yet been received, the quit command is inputted (step twenty-five or step thirty-three).

When the end of video-out is reached (Y; step twenty-three), then it is determined if the stored value C(e) is equal to the stored value C(q). This will be affirmative when the portion of the program that was recorded when the quit command was entered has been played back. If C(e) does not equal C(q), then it is determined if the quit command has been inputted yet by checking if C(q) is equal to 0. If C(q) is still equal to 0, then the end of the time shifting operation has not yet been determined.

The quit command is inputted by the user when it is desired to end the time shifting operation and stop recording the video-in signal for later time shifted viewing. When the user inputs the quit command, the current counter value of vcrR is determined and stored as value C(q) in the data storage device 18. The recording on vcrR may continue so that the TV channel being recorded can be later viewed, or recording can stop all together.

If the quit command has not yet been received (Y; step thirty-eight), then control goes back to step seventeen, and the end of the video-in is recorded on vcrR (in this, the second iteration of the loop, the VCR2 14) at new counter-value C(e) which is stored in the data storage device 18, and the algorithm continues as described above. At the start of each iteration of this loop, the recording VCR (vcrR) becomes the playback VCR (vcrP) and vice-versa (step eighteen). Thus, the entire television program is available for time-shifted viewing.

Until the quit command is entered, the time shifting operation continues even after the initial television program has ended. The television programs that are on the same channel as the initial program can be watched in a time shifted manner. If the user wishes to watch another channel in a time shifted manner, then he inputs the quit command to end the time shifting of the current TV channel, switches to another channel, and then inputs the pause command to begin time shifted viewing of the new TV channel.

If the quit command has been entered, then C(q) does not equal 0 (N; step thirty-eight) and control goes to step thirty-nine where the recording VCR (vcrR) becomes the playback VCR (vcrP) and vice-versa (step thirty-nine). In order to end the time shifting operation, the stored value C(e) becomes equal to the stored value C(q) (step forty). Next, vcrP is then rewound until the stored value C(s) is reached on the VCR's tape counter, and then playback of video-out begins from vcrP. Playback continues until either the pause command is received (step twenty-eight) or the end of the last recorded portion of the program has been displayed (Y; step twenty-three). Since C(e) has been made equal to C(q) in step forty, then the values are compared again in step thirty-seven the time shifting operation will end (step forty-two). At the end of the time shifting operation, control can return to step one where the system is reset and made ready for the next time shifting operation.

A copy of the entire program can be obtained at a later time if: the program recording begins when the program begins; the recorded portions are not destroyed; and the counter-values that indicate at least one of the beginning and the ending of each recorded portion are stored.

To give the user the option of obtaining a complete recording of the program a third VCR can be employed to receive the recorded portions of the program in the correct sequence from each of the two VCRs used to effect the above-described time shifted viewing. If a copy of the entire program is desired, then one of the VCRs is controlled to record the program from the beginning of the program (i.e., before the first user-determined pause) and the counter-values C(s) and C(e) for this recorded portion are stored. During the time shifted viewing operation each of the counter-values C(s) and C(e) are stored as well. During the time shifted viewing operation the VCRs are controlled so as to keep the recorded portions from being destroyed (that is, the recorded portions are not re-recorded over). Thus, after the initial recorded portions on each VCR, each recorded portion on each VCR begins after the end of the last recorded portion that had been played back.

After the program has been recorded on the two VCRs, the recorded segments are played back in the correct sequence as dictated by the stored counter-values C(s) and/or C(e). This resulting video signal is fed to a third VCR on which the program is re-recorded in its entirety (or what ever portion of it is available from the two VCRs).

The configuration shown in FIGS. 7 and 8, and described herein illustrates only on possible construction of the inventive time shifting recording device. The VCRs can be substituted by other video recording/playback devices, such as DVD drives, computer hard drives, flash memory, eeprom, etc. In one practical construction, all the components except for one of the video storage devices is incorporated into a single unit. For example, an Internet appliance can include the microprocessor 10 (computer CPU) and a DVD-Ram drive (with the DVD-Ram possibly also functioning as a computer hard drive). An existing VCR (or other video storage device) can be used as the second video storage device. This configuration enables the unique attributes of the inventive time shifting recording device while reducing complexity and cost by utilizing the video recording/playback capabilities of an already existing VCR.

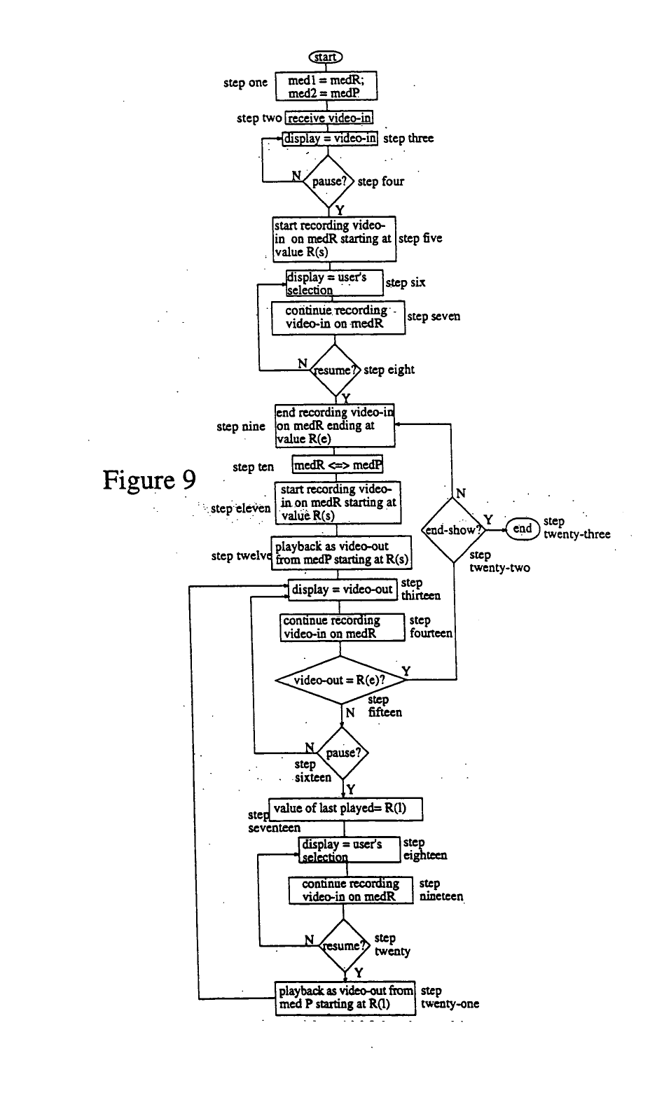

FIG. 9 is a flowchart of an algorithm showing the operational steps of the configuration of the inventive time shifting event recorder. This operation of this flow chart is similar to that of the flowchart shown in FIG. 7. However, this flowchart illustrates the general steps of the inventive time shifting recording method. In this case, the recording mediums can be any combination of recording devices that are suitable for recording video and playing back video information, including, but not limited to magnetic tape, magnetic disks, optical disks, electronic circuits, etc.

At the start of operation, the recording mediums (med 1 and med2 are designated as medR and medp, respectively) (step one). The video signal is received as video-in (step two) and video-in is displayed (step three). As long as a pause command is not received N; step four) video-in continues to be displayed. Once the pause command is received (Y; step four), a segment of video-in is recorded on medR starting at value R(s) (step five) and the pause begins. During the pause, the display shows the user's selection (step six) which as discussed herein might be an Internet web site, another television program, a prerecorded program (which may be included on the recording mediums med1 and/or med2 and/or on a third medium), etc. The recording of video-in on medR continues (step seven) until a resume command is received (Y; step 8).

Once the resume command is received, the end of video-in is recorded on medR ending at value R(e) (step nine), and medR becomes medP, and medP become medR (step ten). The recording of another segment of video-in begins on medR starting at value R(s) (step eleven), and playback as video-out of the previously recorded segment from medP begins starting at R(s) (step twelve). Note: R(s) of medP is not the same as R(s) of medR. The video-out is displayed (step thirteen) and continues to be displayed (step fourteen) until either a pause command is received (step sixteen) or the end of the recorded segment is reached (step fifteen). If a pause command is received (Y; step sixteen) then the playback of video out is paused and, in an optional step, the value of where the playback is paused is saved as R(l) (step seventeen). The user's selection is displayed during the pause (step eighteen) and recording of video-in continues on medR (step nineteen). When the resume command is received (Y; step twenty) then playback of video-out continues from medp starting at R(l) (step twenty-one) and control goes back to step thirteen and video-out is displayed. When the end of playback of the recorded segment from medP is reached (Y; step fifteen), then it is determined if the end of the show has been reached or if the user has selected to end the time shifting operation (step twenty-two). If the time shifting operation is to continue (N; step twenty-two) then the program continues from step nine wherein the end of video-in on medR is recorded at value R(e) (step nine) and the playback medium (medP) becomes the recording medium (medR) and vice versa.

Using recently developed compression schemes, it is now possible to transmit a movie at substantially faster-than-real-time data transfer rates, For example, U.S. Pat. Nos. 4,963,995 and 5,057,932, to Lang describe a burst mode transmission of audio/video program information in a burst period of time that is substantially less than the time required for real time viewing of that audio/video program information. U.S. Pat. No. 5,440,334 to Lang describes how this burst mode transmission of audio/video program information can be used to provide a video distribution system that will allow subscribers to the system a choice between a number of video programs in a type of video-on-demand (VOD) system. However, as with the prior attempts at a VOD system, the subscriber must wait until the entire program has been transmitted to and recorded on the subscriber's VCR (or, presumably, other video recording device) before viewing of the selected program begins.

In accordance with the present invention, a VOD-type system is provided that enables a subscriber to begin viewing the selected program even while it continues to be received. Thus, the subscriber does not have to wait for the entire program to be received before viewing begins, making the present invention a substantial improvement over previous VOD-type systems.

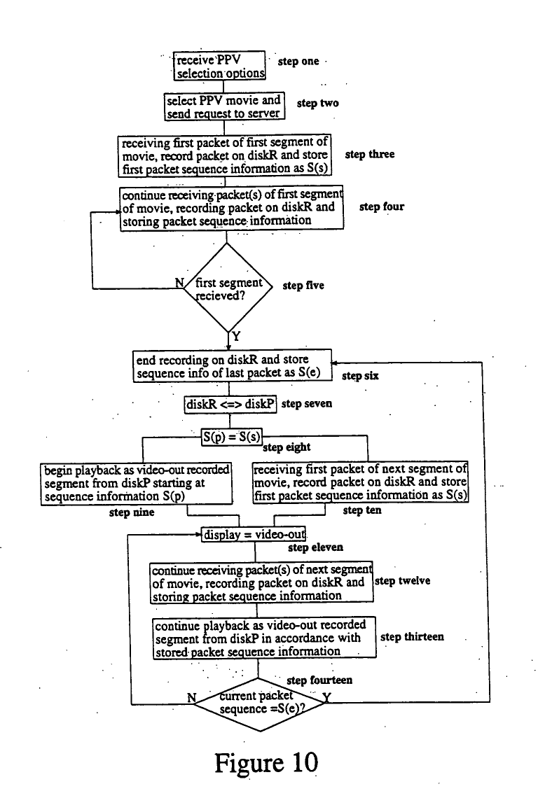

FIG. 10 is a flowchart showing the operation of the present invention for use in an enhanced pay-per-view (PPV) movie system. A subscriber receives pay-per-view (PPV) selection options (step one). Of course, the received programs do not necessarily have to be of the pay-per-view type, but can be any TV program or movie or other data stream. The subscriber selects a PPV movie and send a request to the system provider (step two). In this illustration, the movie data is transmitted in received as packets of data, either compressed (e.g., burst mode) or uncompressed. In the case of uncompressed transmissions, the received PPV movie is viewed like a conventionally received television program, but with the time shifting features (user determined pauses, replays, etc.) described herein. In the case of compressed data, the faster-than-real-time transmission capability allows for enhanced features as described below. The first packet of data of the first segment of the move is received and recorded on diskr (step three). It is possible that the data packets will not be transmitted in chronological order. That is, the packets may be received by the subscriber as they become available on the system. Thus, the packets may include packet sequence information that is used to ensure that the recorded packets are replayed in the correct time sequence. In this case, the first packet sequence information may be stored, for example, in RAM, at a memory location designated S(s) (step three). The packets of the first segment of the movie continue to be received and recorded on diskR, while the packet sequence information for the received packets is stored (step four). As in the other embodiments and configurations described herein, it may be possible to substitute different recording mediums for diskr and diskP (e.g., tape, electronic memory, etc.). As long as the first segment of the program is still being received (N; step five), the packets of the first segment of the movie continue to be received (step four). In this example, the first segment of the movie encompasses a length of viewing time that is appropriate in terms of the PPV system requirements and limitations. Specific timing examples are described below which illustrate this.

Once the first segment is received )Y; step five), the recording of diskr ends and the sequence information of the last packet (in terms of viewing time sequentially) is stored as S(e) so that the end of the first segment can be later determined (step six).

As with the other example flowcharts, diskR becomes diskp and vice-versa (step seven). To facilitate operation, the value of S(s) is given to variable S(p) (step eight). Playback of the recorded segment on diskP as video-out begins starting at sequence information S(p) (step nine), while the first packet of the next segment of the movie is received and stored on diskR and the first packet sequence information is stored as S(s). Video-out is displayed (step eleven) and the viewer watches the selected movie. The packets of the next segment of the movie continue to be received and recorded (step twelve) while playback of the recorded segment in accordance with the stored packet sequence information continues (step thirteen). The packets of the movie data do not necessarily have to be received in the correct chronological order, the sequence information is used to ensure that during playback the movie is viewed in the correct time sequence.

The end of the recorded segment that is being played back is determined by detecting when the current packet sequence being played back is S(e). If the end is not reached (N; step fourteen), then video-out continues to be displayed (step eleven); the received packets continue to be recorded on diskR (step twelve); and the playback for the recorded segment from diskp (step thirteen), continues.

Once the end of the recorded segment has been reached (Y; step fourteen), the control goes to step six and the selected PPV program continues to be viewed and recorded in the time shifted manner described herein.

This flowchart illustrates how the present invention can be used to allow a subscriber to begin viewing a selected program soon after it is selected from a PPV or VOD system, In conventional PPV and VOD systems that take advantage of burst mode or compressed data transmissions, the entire program must first be received before it can be viewed. In systems that transmit the PPV or VOD selection in real time, the movie is viewed in the manner of a broadcast television program. The present invention, on the other hand, allows the viewer to begin viewing a compressed transmission movie well before the entire movie is received and recorded, and the enhanced features of user-determined pauses, replays, etc. described herein are available with either compressed or real-time-transmitted movies.

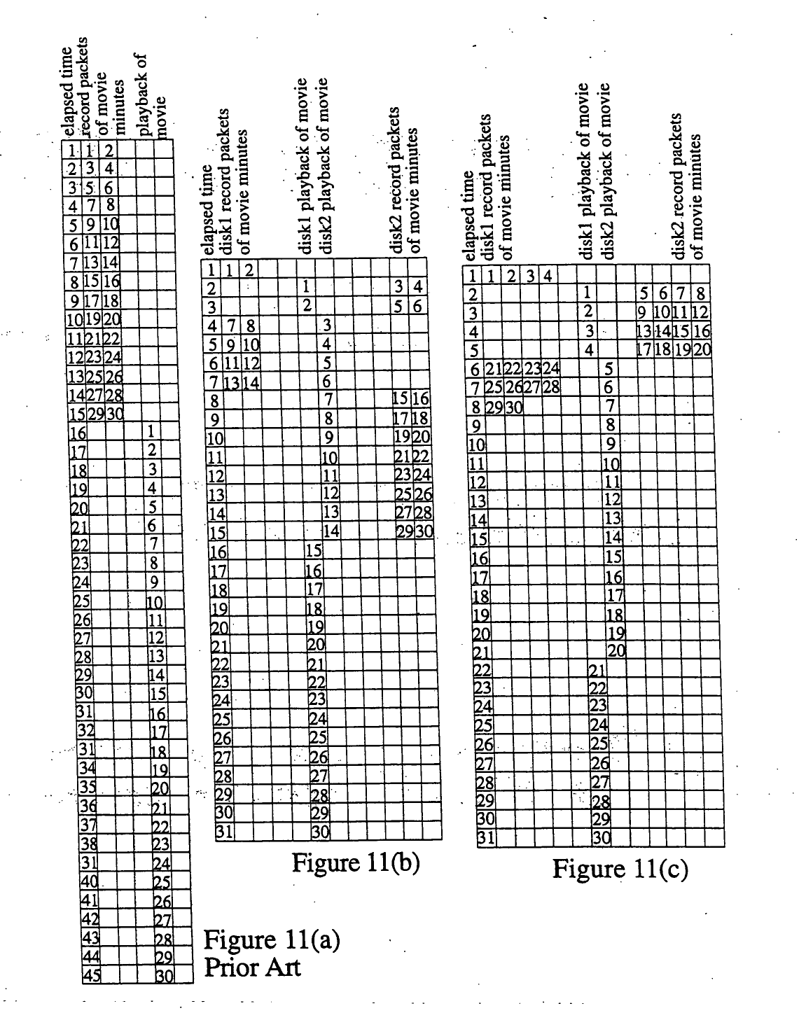

FIG. 11(a) shows the timing of a movie selected from a VOD system that transmits the video data compressed 2:1. In this case, once the movie begins to be received, the viewer must wait fifteen minutes for the transmission of a movie with a viewing length of thirty minutes. Once the entire movie has been transmitted, the subscriber can begin viewing.

In contrast, FIG. 11(b) shows the timing of a movie selected from a VOD-type system in accordance with the present invention. The compression rate and minutes shown are for illustrative purposes, the timing of an actual compressed movie will vary depending on factors such as compression rate, transmission error corrections, etc. In this case, the first segment of the movie is transmitted (along with its sequence information if necessary) in the first minute of elapsed time and recorded on disk1. The first segment contains the first two minutes of the movie. Once the first segment is received, it is played back from disk1 beginning at minute 2 of the elapsed time. While the first segment is being played back from disk1, the next segment of the movie is received and recorded on disk2 during minutes 2 and 3 of the elapsed time. The inventive time shifting recording and playback operation continues in the manner described herein thereby allowing the viewer to view the entire program without having to wait for the entire program to be received. In this example, the viewer would have had to wait 15 minutes for the movie to be received (see, FIG. 11(a)) before viewing could start. In accordance with the present invention, the viewer begins viewing the movie as soon as the first segment of it has been received. Of course, the viewing length of the first segment could be even shorter, making the time for it to be received (the time before viewing begins) less.

FIG. 11(c) shows the timing of a movie selected from a VOD-type system as in FIG. 11(b). In this case, the compression ratio is 5:1, meaning that five minutes of movie viewing are transmitted each minutes. In this case, the viewer received the firs five minutes of the movie in the first minute of transmission.

FIG. 12(a) is a flow chart of an algorithm showing an embodiment of the inventive method for enabling near video-on-demand (VOD) service using a digital video recorder (DVR) for the simultaneous storage and playback of multimedia data. In accordance with the present invention(s) a method is provided for enabling near VOD service using a DVR for the simultaneous storage and playback of multimedia data, whereby a VOD selection can begin playing on a display device shortly after being requested from a multimedia network source.

In accordance with the embodiment of the inventive method shown in FIG. 12(a), near video-on-demand (VOD) service is enabled using a digital video recorder (DVR) for the simultaneous storage and playback of multimedia data. The inventive method includes the steps of connecting a DVR to a multimedia network source (step one). A VOD selection is requested by the DVR from the multimedia network source (step two). A multimedia data signal is received by the DVR from the multimedia network source (step three). The multimedia data signal contains the requested VOD selection. A first received segment of the received multimedia data signal is stored on the DVR (step four). The first received segment is played by the DVR for display on a display device (step five). Simultaneously during the playing of the first received segment, a second received segment of the received multimedia data signal is received from the multimedia network source and stored on the DVR while the first received segment is played the display device (step six). Thus, in accordance with the present invention, the requested VOD selection begins playing on the display device prior to the reception of the entire compressed multimedia data signal. By this inventive method a requested VOD selection can begin being displayed nearly instantaneously after the request for it is made.

FIG. 12(b) is a flow chart of an algorithm showing another embodiment of the inventive method for enabling near VOD service. In accordance with the inventive method for enabling near VOD service, the DVR is connected to a network server over a data network (step one). The data network may include, but is not limited to, the Internet, satellite, cable television, broadcast television, powerline, phoneline or wireless networks. The VOD selection is requested by the DVR from the network server (step two). A compressed multimedia data signal is received by the DVR from the network server (step three) and a first received portion is stored in memory associated with the DVR (step four). The memory may include a disk drive incorporated in the DVR and used to enable the inventive time shifting recording and playback features described herein. The memory may alternatively or in addition include a removable storage medium, such as DVD-RAM, solid state memory, video tape, or any other fixed or removable memory system capable of storing useful amounts of video and audio data. The compressed multimedia data signal contains the requested VOD selection. In this case, the first received segment of the received multimedia data signal is decompressed by the DVR (step five) before the decompressed first received segment is display on the display device, such as a television or computer monitor (step six). Simultaneously during the playing of the first received segment, a second received segment of the received multimedia data signal is received from the multimedia network source and stored on the DVR while the first received segment is played the display device (step seven). Thus, the requested VOD selection begins playing on the display device prior to the reception of the entire compressed multimedia data signal containing the requested VOD selection.

In accordance with the present invention, the entire VOD selection may be transmitted as packetized computer network data from the network server to the DVR. For example, a broadband, satellite, DSL or other high speed Internet connection may be used to transmit the VOD selection from the network server to specific DVR requesting the VOD selection. As an alternative, to improve efficiency and conserve bandwidth, a first portion of the VOD selection may be transmitted as packetized network computer data transmitted over a client-server type computer network, such as but not limited to the Internet. A second portion of the VOD selection is transmitted as video data carried over a broadcast network, such as but not limited to National Television Standards Committee (NTSC) broadcast, PAL broadcast, satellite transmission, DSS, DBS, ATSC and the like. In this case, more than one user of the inventive VOD system may request the same VOD selection. However, the requested start-time for the VOD selection of each individual DVR user may be different. In accordance with this aspect of the invention, the individualized client-server type network connection is used to transfer a portion of the VOD selection so that each DVR user can being viewing the selection nearly instantaneously. To conserve bandwidth and make the system more efficient, a second portion of the same VOD selection is transferred simultaneously to the multiple DVR users requesting the same selection. This second portion is stored on each individual DVR and played at the appropriate time after the first portion has finished playing.

The second portion may also be received over a broadcast network before the reception of the first portion received over a client-server type computer network. In this example, the beginning minutes of a number of available VOD selections may be stored on individual DVRs connected with the inventive VOD system. A user can select which VOD selection to view and start viewing it immediately from the DVR storage. Automatically upon the user's selection to view a particular VOD selection, a connection with the network server may be made to being the transfer of the rest of that VOD selection. The multimedia signal thus downloaded is received simultaneously with the playing of the portion of the VOD selection already stored on the DVR. The inventive method for simultaneously receiving and playing the multimedia signal may then be utilized to continue the uninterrupted viewing of the VOD selection in a very efficient, real-time video-on-demand manner. The prestored portion of the requested VOD selection may be prestored on the DVR or a local storage device associated with the DVR. The prestored portion is played at an appropriate chronological time during the playing of the VOD selection. Another portion of the requested video signal is received over a client-server type computer network, whereby a portion of the requested VOD selection may be prestored on a local storage device, and another portion of the requested VOD selection is transmitted upon request made to the network server.

FIG. 12(c) is a flow chart of an algorithm showing another embodiment of the inventive method for enabling near VOD service. In accordance with this embodiment of the inventive method for enabling near VOD service, a request is received from a DVR for a VOD selection by a network server connected to the DVR over a data network (step one). The requested VOD selection is retrieved from a storage device associated with the network server (step two). The requested VOD selection is transmitted in the form of a multimedia data signal over the data network to the receiving DVR (step three). A first received segment (step four) of the received multimedia data signal is stored on the DVR (step five). The first received segment is decompressed as necessary by the DVR (step six) and played on a display device (step seven). Simultaneously during the playing of the first received segment, a second received segment of the received multimedia data signal is received from the multimedia network source and stored on the DVR while the first received segment is played the display device (step seven). Thus, in accordance with the present invention, different segments of the multimedia data signal are simultaneously played and recorded by the DVR in the manner described herein so that the requested VOD selection can begin being displayed nearly instantaneously after the request for it is made.

In accordance with the present invention, the compressed multimedia data signal may have a compression value that enables reception of the VOD selection faster than the real-time playback of the VOD selection on the display device. In this case, for example, it might take 15 minutes to receive 30 minutes of real-time video and audio information. The inventive method in this case will allow a user to begin viewing the VOD selection nearly instantaneously after requesting it, without having to wait for the entire data file containing the VOD selection to be downloaded.

Alternatively, the compressed multimedia data signal might have a transfer rate over the data network that does not enable the real time playback of the VOD selection on the display device. In this example, it might take 30 minutes to receive 15 minutes of real0tmie video and audio information. In accordance with the present invention, the start of play and a playing time length of the first received portion can be automatically controlled depending on the transfer rate so as to enable a delay in the start of playing of the VOD selection effective to compensate for the transfer rate. In this manner, substantially the entire VOD selection is displayable on the display device in a continuous manner. In this simple example, utilizing the inventive method a 15 minute requested VOD selection that will take 30 minutes to download can begin playing just 15 minutes after the request. That is, the viewer does not have to wait 30 minutes before the start of viewing, and the entire VOD selection is played in an uninterrupted manner. Further, the transfer rate over a computer network, such as the Internet, often varies depending on factors such as modem speeds, type of connections, current Internet traffic, error correction, etc., etc. In accordance with the present invention, the current transfer rate (and/or the anticipated transfer rate during the VOD download) can be determined either by the network server or a device associated with it or by the client DVR, and the start time of the first received portion automatically controlled depending on that determined transfer rate.

Furthermore, in the case where the compressed multimedia data signal has a transfer rate over the data network that does not enable the real time playback of the VOD selection on the display device additional steps may be performed. Thus, in accordance with the present invention, to enhance the viewing options, improve the level of service and create an avenue for revenue to the system provider, time-filling information may be pre-stored on the DVR. This time-filling information may include, but is not limited to, video commercials, webpages, video news casts and the like downloaded or otherwise made available for playback on the DVR. In accordance with this aspect of the invention, the prestored time-filling information is automatically retrieved and displayed on the display device at a time when the VOD selection is not displayed.

In addition, oftentimes a user will wish to make a request for a VOD selection to be played on the user's DVR using a device other than the user's DVR. For example, the user may be using a computer to connect to the Internet at the office and would like to have a VOD selection waiting for him when he returns home. In this case, the request for the VOD selection can be made from a network device having a network connection other than the network connection connecting the DVR with the network server. That is, the user can request the VOD selection from the office computer and begin the transfer of the multimedia signal to the home DVR at an appropriate time. The DVR may be controlled to record the VOD selection via control data transmitted over the network from the network server, in response to the request from the network device. Of course, appropriate password and encryption techniques may be employed to insure the security of the inventive VOD system.

Further, the DVR may be addressable by a remote network device, including but not limited to the network server, for receiving the control data. For example, the DVR may be addressable by the network server so that a network connection between the network server and the DVR enables the DVR to receive the control data. In this case, the network server may initiate a network connection with the DVR, or the DVR may be programmed to communicate with the network server at predetermined times.

In accordance with the present invention, the multimedia data signal may include at least one of audio, video and webpage data. The webpage or audio data can be used as the time-filling information, or used to supplement and enhance the VOD selection. Further, the webpage data may include links to online content that serves as time-filling information. Once an appropriate amount of the VOD selection has been received by the DVR, an alert can be generated letting the user know that the selection is now available for viewing, or the DVR can be controlled to automatically begin playing the VOD selection when it becomes available for viewing. Further, scene transitions, such as periods of black display screen information or fade to black type display information can be detect, and the time-filling information automatically inserted for display upon such detected scene transitions. In this manner, the continuity and viewability of the requested VOD selection may be enhanced, and an avenue for revenue to the VOD service provider may be created.

In accordance with the present invention, the multimedia data signal may further include identifying information pertaining to at least one of the requested VOD selection, the DVR, information regarding a user of the DVR, information regarding an account associated with the DVR. In this case, the DVR may be controlled for automatically transmitting at least a portion of the identifying information back to the network server. This information may be used for billing, automatic VOD suggestions, copyright protection, and the like. Further, the requested VOD may be automatically deleted from the DVR (by controlled erasing of the DVR storage device) after a set period of time and/or number of viewings of the requested VOD selection.

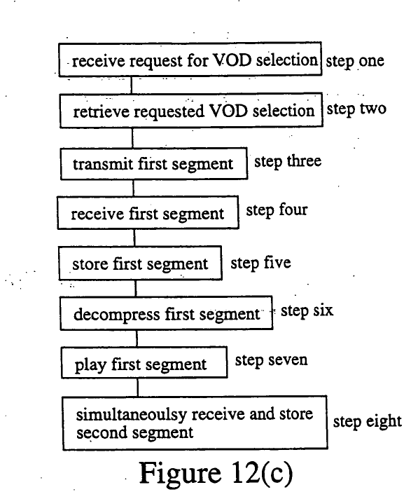

FIG. 13(a) is a schematic diagram illustrating the transmission path of data between a source of VOD selections and a client machine. In accordance with an aspect of the present invention, the request for a VOD selection may be made over a VOD requesting connection, which may be an Internet broadband, dialup, DSL, satellite, wireless, or other network connection. Alternatively to the Internet, a direct client-server connection may be made. The VOD receiving connection may be made via a computer network data such as the Internet from a remotely located network server to the individual DVRs of subscribers to the inventive video-on-demand system. The VOD receiving connection may also be based on cable, satellite or broadcast television signals, or carried over the phoneline, powerline or wirelessly to the homes of subscribers to the inventive video-on-demand service.

Portions of the requested VOD selection may be received over a broadcast network before the reception of the other portions received, for example, after a specific request over a client-server type computer network. The beginning portions, movie trailers, or other inducements for a number of VOD selection choices may be stored on individual DVRs connected with the inventive VOD system. A user can select which VOD selection to view and start viewing it immediately from the DVR storage. Automatically upon the user's selection to view a particular VOD selection, a connection with the network server may be made to being the transfer of the rest of that VOD selection. The prestored choices can be based on selections made by the DVR user, suggestions based on prior VOD selections, user demographics or special promotional offerings.

FIG. 13(b) is a schematic diagram illustrating another transmission path of data between the source of VOD selections and a client machine. In particular, in the case of an Internet network connection, the compressed multimedia data signal may have a transfer rate that does not enable the real time playback of the VOD selection on the display device. To enhance the viewing options, improve the level of service and create an avenue for revenue to the system provider, time-filling information may be pre-stored on the DVR. This time-filling information may include, but is not limited to, video commercials, webpages, video news casts and the like downloaded, transmitted over cable, broadcast or satellite bandwidth, or otherwise made available for playback on the DVR. Each DVR on the inventive VOD system may be addressable so that it can be specifically controlled via information transmitted from a remote network server to tune to and record VOD selections, time-filling, and other information. The prestored time-filling information can be automatically retrieved and displayed on the display device at a time when the VOD selection is not displayed. Targeted commercials may be transmitted during network (client-server or broadcast) as allowed by available bandwidth and space on the individual DVRs (part of the identifying information transmitted from the DVR may include available recording space). These commercials may be played during the delays and at preset times. Detecting fade to black or other likely scene transitions enable the insertion of such commercials automatically at logical breaks in the VOD selection

A request for a VOD selection to be played on the user's DVR using a device can be made by connecting to the Internet from a device other than the user's DVR. The request for the VOD selection is received by the network server, along with appropriate password or other account identifying information, and the transfer of the multimedia signal to the home DVR is initiated automatically by the network server at an appropriate time. The DVR may be addressable by a remote network server for receiving the control data needed to automatically begin the recording of the VOD selection

The multimedia data signal may also include identifying information pertaining to at least one of the requested VOD selection, the DVR, information regarding a user of the DVR, information regarding an account associated with the DVR. In this case, the DVR may be controlled for automatically transmitting at least a portion of the identifying information back to the network server. This information may be used for billing, automatic VOD suggestions, copyright protection, and the like. Further, the requested VOD may be automatically deleted from the DVR (by controlled erasing of the DVR storage device) after a set period of time and/or number of viewings of the requested VOD selection. FIG. 13(c) is a schematic diagram illustrating another transmission path of data between the source of VOD selections and a client machine. In this case, the transmission path includes a satellite television service. This satellite television service may include a pathway for transmitting the VOD selection request from the DVR to the remote network server, or a separate pathway, such as an Internet connection can be used. Separate data channels included in the satellite television bandwidth can be used to transmit the multimedia data signal, with the appropriate DVRs controlled to tune and record the requested VOD selections. Further, the priority of these broadcasted VOD selections can be determine to maximize the usage of the available bandwidth. For example, if 10,000 subscribers request VOD selection A and 100 subscribers request VOD selection B, VOD selection A is given priority and made available on the satellite bandwidth sooner than VOD selection B.

FIG. 13(d) is a schematic diagram illustrating another transmission path of data between the source of VOD selections and a client machine. To improve efficiency and conserve bandwidth, a first portion of the VOD selection may be transmitted over the Internet from the network server to the requesting DVR. A second portion of the VOD selection may be transmitted over a broadcast network, such as but not limited to National Television Standards Committee (NTSC) broadcast, PAL broadcast, satellite transmission, DSS, DBS, ATSC and the like. Thus, more than one user of the inventive VOD system may request the same VOD selection. But, the requested start-time for the VOD selection of each individual DVR user may be different. The individualized client-server type network connection over the Internet is used to transfer a portion of the VOD selection to each requesting DVR in an individualized (or synchronized to two or more requesting DVDs if possible) manner. Thus, each user can being viewing the selection nearly instantaneously. To conserve bandwidth and make the system more efficient, a second portion of the same VOD selection is transferred simultaneously to the multiple DVR users requesting the same selection. This second portion is stored on each individual DVR and played at the appropriate time after the first portion has finished playing.

The second portion may also be received over a broadcast network prior to the reception of the first portion received over the Internet connection. The first few minutes of a number of available VOD selections may be received any time during the day and night, and stored on the individual DVRs controlled to tune in and record depending on user profile data, viewing suggestions, specific VOD requests, etc. Later, each user can select which VOD selection to view and start viewing it immediately from the DVR storage. Automatically upon the user's selection to view a particular VOD selection, a connection with the network server may be made to being the transfer of the rest of that VOD selection, or if the selection is available on the broadcast bandwidth, the DVR may be controlled to tune to the appropriate channel and begin recording. Any portion that is not available within the appropriate timeframe for uninterrupted (or within some determined tolerance) viewing can be obtained by a specific request to the network server over the Internet. The multimedia signal can thus be obtained from a combination of broadcast and client-server type downloads, and portions may be received simultaneously with the playing of other portions of the VOD selection already stored on the DVR. The inventive method for simultaneously receiving and playing the multimedia signal may then be utilized to continue the uninterrupted viewing of the VOD selection in a very efficient, real-time or near video-on-demand manner.

An inventive video-on-request (VOR) system is described below. The individualized information transfer capabilities of a network server farm and bulk information transfer of satellite or cable TV bandwidth are utilized so that a requested VOR selection is available for playback on the subscriber's TV shortly after the request is made. After reviewing thousands of movie choices, each VOR subscriber submits a prioritized list of movie selections. The server farm determines the transmission priority of transmitted movie selections based on a statistical analysis of all the requested movie selections made by all the subscribers. In this case, the show may be transmitted to the DVR over a satellite or cable TV connection, and each subscriber's DVR is automatically controlled to record only the movies on their prioritized list. Encryption and Copy Protection are used to safeguard against pirated viewing or copying. This system enables an efficient use of available bandwidth, and opens the opportunity for a variety subscription plan choices. Making it more likely that a potential subscriber will find a suitable subscription plan.

In accordance with the present invention, VOR selection data is received from a plurality of VOR users. Each VOR selection data includes at least one requested video selection and video recorder identifying information for identifying a particular video recorder of each of said plurality of users. The received VOR selection data is stored on the server so that data from the plurality of users can be collected. This data is used to statistically determine the best transmission pathway and time for transmitting the various selected video selections. The server performs a statistical analysis of the stored VOR selection data. Using the statistical analysis transmission times are determined for each said at least one requested video selection. Personal video recorder control signals are transmitted from the network server to the personal video recorders. The control signals transmitted to each personal video recorder depend on the received VOR selection data and the determined transmission time and pathway of each video selection requested by each VOR user. Thus, if the received VOR selection data from a user includes a request for a particular video selection the user's personal video recorder is automatically controlled to record the video selection. An encrypted version of the particular video selection can be transmitted to all of the video recorders, for example using a broadcast transmission pathway. In this case, control signals are transmitted to the specific video recorders so that they can be automatically controlled to record the encrypted particular video selection. This will allow a user to have prestored on his personal video recorder a video selection that may be of interest. If the user wishes to view the stored encrypted video, a request is made from the network server (or another server dedicated to billing and account control, for example. The encryption key is then transmitted to enable playback of the encrypted video selection. Thus, in the case the video recorder is controlled to automatically record the particular video selections requested by a particular user and playback of the recorded particular video selections is enabled upon request from the user. Further, the transmission priority may also dependent on a length of time a requested video selection has been pending, so that even video selections that would fail to be transmitted due to a low number of requests can be transmitted to the subscribers.

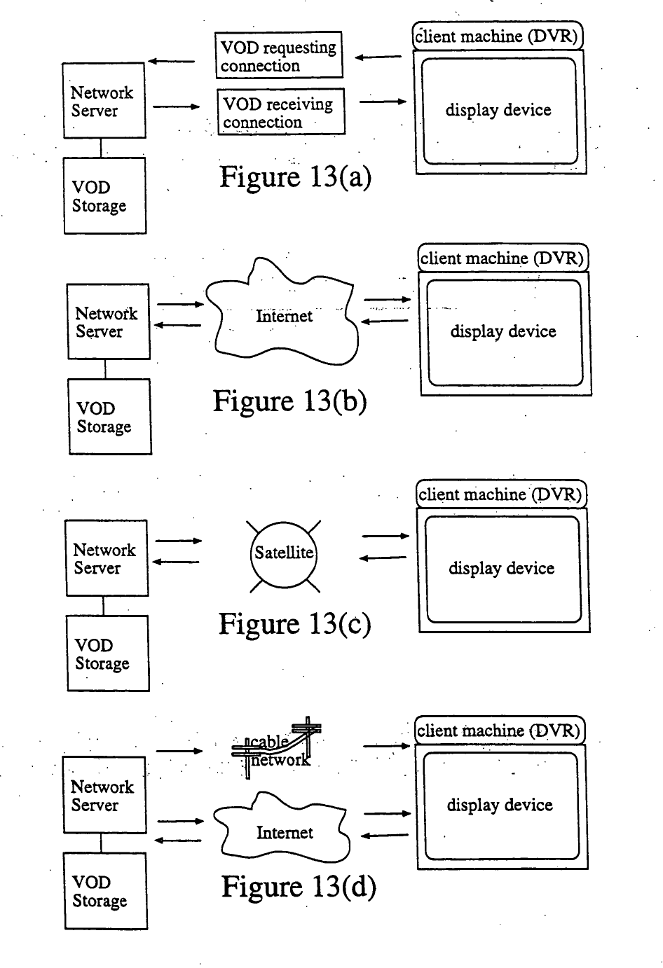

FIG. 14 is a flow chart showing the basic steps of the inventive video-on-request (VOR) system. A Video-On-Request (VOR) system can provided to enhance the capabilities of personal video recorders or digital video recorder, or other video recording devices, such as VCRs, computers, set top boxes (connected to or incorporating a storage device) and the like (generally referred to herein as a DVR). In accordance with this aspect of the invention, an HTML-type web site is accessed by subscribers to search for movies and create a prioritized list of movie selections. Using hyperlinks and HTML forms, VOR selection data is transmitted to a network server, or other centralized database device, from multiple subscribers (step one). Each VOR selection data includes the prioritized movie list. Also included in the transmitted VOR selection data is box identifying information for identifying each subscriber's particular DVR.

A transmission priority for movies transmitted from the server farm is determined (step two) depending on a statistical analysis of all the requested movie selections received in a specific period, such as each day. For example, the transmission priority may depend solely on how many times a particular movie selection is requested. In this case, the transmission priority of a particular movie selection depends on the frequency of the requests for it. A “best” transmission time is then determined for each transmitted movie selection (step three) dependent on the transmission priority. One or more transmission pathways may be available. For example, the bandwidth (that is, TV channels) available for VOR transmission on a satellite TV system may vary from time to time. A “best” transmission pathway is chosen (step four) for each transmitted movie selection. The transmission pathway might include at least one of satellite, broadcast, cable, broadband, wireless, power line, phone line, etc.

DVR control signals are then transmitted from the network server to the subscribers' DVR boxes (step five). The control signals may be transmitted over the Internet, or through the other transmission pathways. The control signals that are sent to a particular DVR depends on the received VOR selection data (identifying information and priority movie list) and the transmission time and transmission channel of the particular movie selection. Thus, each DVR is automatically controlled to record only the subscriber's requested movie selections. The DVR is automatically controlled to tune in the determined transmission channel at the determined transmission time and record the particular movie selection. The particular movie selection is transmitted from the network server at the determined transmission time and transmission channel (step six).

Thus, during the transmission of a particular movie selection, the DVR of each subscriber requesting that particular movie selection is controlled to automatically record it. In this manner, all of a subscriber's personalized movie selections become available for viewing from his or her DVR. The more popular the selection, the sooner the movie is likely to be available for viewing from the subscriber's DVR. Thus, recently released movies are likely to be available for viewing quickly. Since the system is available for transmitting 24 hours a day, and multiple transmission pathways can be simultaneously employed, even an obscure movie selection will soon become available on a subscriber's DVR. Further, as high speed access become more ubiquitous, a direct Internet pathway can be used to transmit less popular movie selections, while the broadcast-type TV bandwidth is used to transmit the popular movie selections. This dual approach reduces the burden on the Internet infrastructure, while still offering a huge variety of VOR choices.

The particular movie selection can be transmitted as an encrypted video data file. In this case, when viewing of the movie is desired, an encryption key is requested from the subscriber. Depending on the subscription plan, the encryption key is transmitted from the network server enabling playing of the encrypted video data file. Various subscription plans can be accommodated. For example, a subscriber may pay for only the movies actually viewed. After a predetermined number of viewings, or after a predetermined length of time, etc., the stored video may be automatically erased from the DVR, or the encryption key automatically terminated. As an example of another subscription plan, each available movie selection might have a predetermined price, and/or a premium service subscription might be available.

As another example, a subscriber may be allowed to have a predetermined number of choices available at any given time. For example, a subscription plan might allow a subscriber to have four choices from his priority list available for viewing at any given time, with no limit on how long or how many times the selection can be viewed. The subscriber “returns” a selection and it become unavailable for viewing, and the next selection from his list is made available. It can be appreciated that this video-on-request service would be adaptable to many subscription plan choices, and thus tend to maximize the popularity and thus the revenue potential for the system.

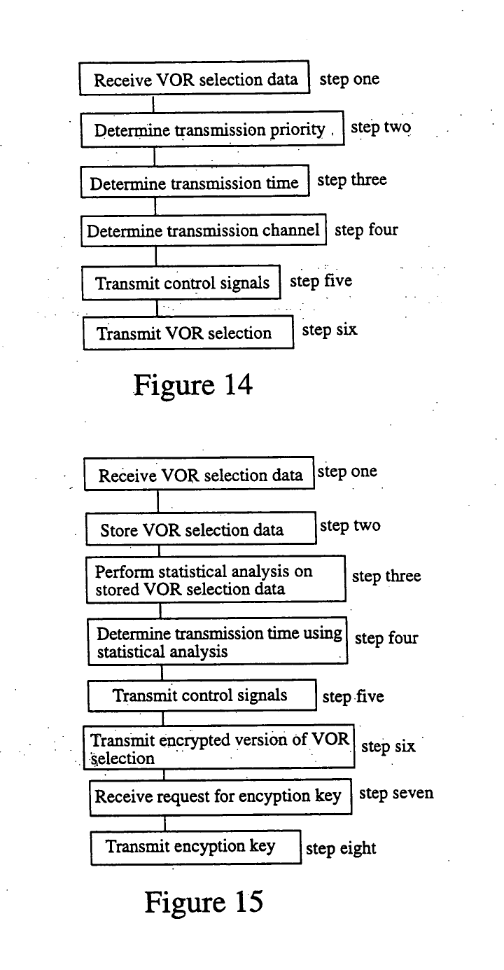

FIG. 15 is a flow chart further describing the steps of the inventive VOR system. The network server receives VOR selection data (step one) and stores the data (step two) as it comes in. After a set period, for example, hourly, every four hour, once a day, after a predetermined number of separate request are received, etc., a statistical analysis is performed on the stored VOR selection date (step three). Using the results of the statistical analysis, the transmission time for each VOR selection is determined (step four). Control signals are then transmitted to the subscriber's DVR so that it will tune in that particular subscriber's VOR selection(s) and record it (step five). In order to reduce pirating, or to make the system more flexible and secure, an encrypted version of the VOR selection can be transmitted (step six) at the appropriate time. For example, the service may provide for the automatic transmission of VOR selections to subscribers based on detected viewing habit, previous requests, survey, demographic data, etc. In this case, at least some of a particular subscriber's available VOR selections may be made available without further input from the subscriber. They simply are loaded onto the subscriber's DVR in accordance to the control signals transmitted to it. In this case, for example, the service may be set up such that a subscriber only pays for those VOR selections that are actually viewed. When a subscriber wishes to view on the stored VOR selections, he requests the encryption key from the network server. The network server receives the request for the encryption key (step seven) and transmits the encryption key to the subscriber's DVR (step eight). This key is then used to decipher the stored encrypted VOR selection so that is can be viewed. In accordance with this aspect of the invention, a VOR service is provided that will enable, for example, a number of movies or other video selections to be prestored and available at any time after reception at the request of the user.

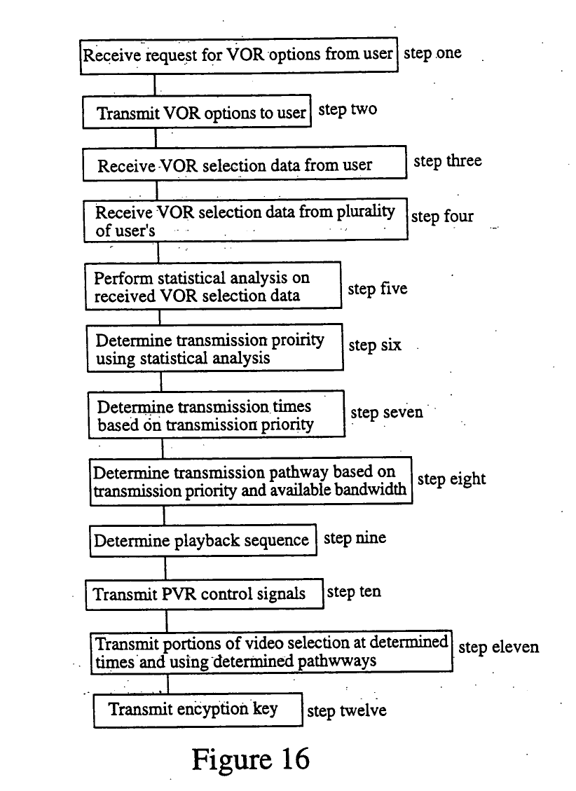

FIG. 16 is a flow chart also further describing the steps of the inventive VOR system. In accordance with this aspect of the present invention, a method for providing a VOR system that utilizes the Internet to transmit selection choices, payment options, manage subscriber account information, allow subscribers to make selections that will be stored on their DVR from any remote location with an Internet connection, and enable of variety of enhanced services and revenue generation vehicles including targeted commercials and product offerings. A subscriber connects with a network server from any Internet connection and logs in (using well know password protection or other security measures). The network server receives a request from the subscriber for VOR options (step one) (selection choices, payment options, etc.) which are transmitted in the form or HTML code or other suitable computer network data (step two).

The subscriber chooses VOR selection data which is received by a centralized database device, such as a network server (step three). The network server also receives selection data from a plurality of other subscribers (step four). Each VOR selection data includes, for example, a requested video selection and video recorder identifying information for identifying each particular video recorder. A statistical analysis is performed of the requested video selections received from the plurality of subscribers (step five). A transmission priority of requested video selections is determined dependent on the results of statistical analysis (step six). The transmission priority of a particular video selection depends on, for example, the frequency of requests received for the particular video selection. A transmission time for the particular video selection is determined dependent on the transmission priority (step seven). A transmission channel or pathway is determined for the particular video selection (step eight). The transmission channel includes at least one of satellite, broadcast, cable, broadband and dialup Internet service and the like.

In accordance with the invention, the particular video selection may be broken into segments transmitted at different times and over different pathways. For example, it may be advantages to transmit just the beginning portion of the particular video selection to the subscribers (those who requested it and, possible also those who may request it at a later date which may be determined by viewing habits or other collected information). Then, when a specific subscriber decides to view that particular video selection, the remaining portion can be downloaded, for example, via the Internet, when the subscriber begins viewing the pre-stored beginning portion.

Similar to the simultaneous playback and record capabilities of the DVR described here, the beginning portion plays back immediately while the remaining portion is received and played back in the proper chronological time frame. The playback sequence of the broken up video selection is determined (step nine) and, if needed, DVR control signals are transmitted to the DVRs depending on the received VOR selection data and the transmission time and transmission channel of the particular video selection (step ten). The portions of the video selection are transmitted at determined times, using determined pathways for recording onto the appropriate DVRs (step eleven). As described above, it is possible that at least a portion of the video selection is going to be transmitted at a time determined by the subscriber when he begins viewing the prestored beginning portion. Further, the particular video selection can be transmitted as an encrypted video data file. An encryption key request may be received by the network server from a user. The encryption key is transmitted from the network server to the DVR to enable playing of the encrypted video data file so that the particular video selection may be displayed at the request of the user (step twelve).

1. A method comprising:
receiving VOR selection data from a plurality of VOR users, each VOR selection data including at least one requested video selection and video recorder identifying information for identifying a particular video recorder of each of said plurality of users;
storing the received VOR selection data;
performing a statistical analysis of the stored VOR selection data;
determining using the statistical analysis transmission times for each said at least one requested video selection;
transmitting personal video recorder control signals to personal video recorders depending on the received VOR selection data and the transmission time of each video selection requested by each VOR user, whereby if the received VOR selection data from a user includes a request for a particular video selection the user's particular video recorder is automatically controlled record the particular video selection;
transmitting an encrypted version of the particular video selection receivable by all of the video recorders so that each particular video recorder can be automatically controlled to record the encrypted particular video selection;
receiving a request for an encryption key for the recorded encrypted particular video selection; and
transmitting an encryption key to enable playback of the encrypted version of the particular video selection upon request from a user, whereby the video recorder is controlled to automatically record the particular video selections requested by a particular user and playback of the recorded particular video selections is enabled upon request from the user.

2. A method as recited in claim 1, wherein the transmission time is also dependent on a length of time a requested video selection has been pending, so that even video selections that would fail to be transmitted due to a low number of requests can be transmitted to the subscribers.

3. A method as recited in claim 1, wherein the personal video recorder control signals are transmitted via the Internet.

4. A method as recited in claim 1, wherein the statistical analysis is performed after a predetermined period of time.

5. A method as recited in claim 1, wherein the statistical analysis is performed after a predetermined number of video selection requests are received.

6. A method as recited in claim 1, wherein the statistical analysis is based on a frequency with which requests for a particular video selection are received.

7. A system comprising:
a network interface for receiving VOR selection data;
a data repository for maintaining the VOR selection data;
a processor configured to perform statistical analysis of the VOR selection data, the statistical analysis based on a frequency of requests for particular video selections;
a control signal transmitter configured to transmit a control signal that directs a digital video recorder to automatically tune to a particular transmission pathway at a particular transmission time to record a video selection that was requested; and
a video transmitter configured to transmit the video selection that was requested via the particular transmission pathway at the particular transmission time.

8. A system as recited in claim 7, wherein the control signal transmitter is configured to transmit the control signal via the Internet.

9. One or more computer-readable media comprising computer-executable instructions that, when executed, direct a computing system to:
receive VOR selection data from a plurality of VOR users, each VOR selection data including at least one request for a video selection and data that identifies a particular video recorder;
perform a statistical analysis based on the VOR selection data that is received;
determine based on the statistical analysis, a transmission time for the video selection;
transmit a control signal to the video recorder identified in VOR selection data that includes a request for the video selection, the control signal causing the video recorder to automatically record the video selection; and
transmit the video selection at the determined transmission time.

10. The one or more computer-readable media as recited in claim 9, further comprising computer-executable instructions that, when executed, direct the computing system to store the received VOR selection data.

11. The one or more computer-readable media as recited in claim 9, further comprising computer-executable instructions that, when executed, direct the computing system to:
transmit the video selection as an encrypted video file;
receive a request for an encryption key associated with the encrypted video file; and
transmit an encryption key to enable playback of the encrypted video file.
